(19) United States
(12) Patent Application Publication
(10) Pub. No.: US 2024/0001823 A1
(43) Pub. Date: Jan. 4, 2024

(54) CHILD SEAT FOR MOUNTING ON A MOTOR VEHICLE SEAT

(71) Applicant: CYBEX GmbH, Bayreuth (DE)

(72) Inventors: Franz PELESKA, Bayreuth (DE); Robert SYKORA, Bayreuth (DE); Harald KOHLMANN, Bayreuth (DE); Lukas STUTTERECKER, Bayreuth (DE)

(21) Appl. No.: 18/250,944

(22) PCT Filed: Oct. 27, 2021
(86) PCT No.: PCT/EP2021/079781

§ 371 Date: Apr. 27, 2023

(30) Foreign Application Priority Data
Oct. 30, 2020 (DE) 20 2020 106 236.0
Dec. 8, 2020 (DE) 10 2020 132 657.2

(51) Int. Cl. B60N 2/28

(52) U.S. Cl. CPC B60N 2/2887; B60N 2/2824; B60N 2/2827; B60N 2/286; B60N 2/2872; B60N 2/2884; B60N 2/2839; B60N 2/2851

(57) ABSTRACT

The invention relates to a child seat for mounting on a motor vehicle seat child seat, said child seat comprising: a seat shell, a side impact protection element which is attached or can be attached to the seat shell and can be transferred between a rest position, in particular located within a predetermined width, and a functional position, in particular located outside the predetermined width, at least one means for making it more difficult to move the seat into the rest position and/or for making it more difficult, or preventing it, from being permanently set to the rest position.

The invention relates to a child seat for mounting on a motor vehicle seat, a system comprising a child seat for mounting on a motor vehicle seat as well as a packaging, a method of packaging a child seat and a method of configuring a child seat.

In the prior art, child seats with side impact protector are known. It is known that the side impact protector can assume a rest position and a functional position, whereby an automated or automatic transfer can be provided if necessary.

In principle, a child seat of this type can for example be derived from EP 2 275 303 A1.

DE 20 2012 102 471 U1 describes a similar side impact protector which can be transferred from a rest position to a functional position, for example by folding out, pulling out or attaching. In the functional position the side impact protector is locked.

In DE 20 2015 104 791 U1 also a solution is described in which a side impact protector can be transferred from a rest position to the functional position. The transfer from the rest position to the functional position is carried out automatically by a position transfer device. In the rest and functional position, the side impact protector is locked. The locking in the rest position is automatically set when the side impact protector is transferred to this position. However, the locking in the rest position can be released by an actuating device (in order to be able to return the side impact protector to its functional position).

US 20 2001 018 76 A1 describes a locking by a latching component both in rest as well as in functional position. The side impact protector is biased towards the rest position.

All solutions in the prior art are considered to be in need of improvement from a safety point of view.

It is therefore object of the invention to provide a side impact protector for a child seat which is particularly safe in use. In particular, the risk of incorrect use or incorrect adjustment is to be reduced. Furthermore, it is an object of the invention to propose a corresponding system comprising a child seat for a motor vehicle seat as well as a packaging, a method for packaging a child seat for mounting on a motor vehicle seat as well as a corresponding method for configuring a child seat for mounting on a motor vehicle seat.

This object is solved in particular by the features of claim 1.

In particular, the object is solved by a child seat for mounting on a motor vehicle seat (for example, of a car or truck), the child seat having: a seat shell, a side impact protector which is attached or can be attached to the seat shell and which can be transferred between a rest position, in particular located within a predetermined width (e.g. standard width of, for example, 440 mm) and a functional position, in particular located outside a predetermined width, and at least one means of impeding a movement (in particular move and/or release of an optional locking/latching of the functional position) into the rest position and/or at least one means (if appropriate the same or a different/further means) of impeding (and/or preventing) a permanent (i.e. in particular without the action of external forces and/or external structures) setting of the rest position. The means of impeding can be (an) independent element(s) or be part(s) of the side impact protector or the seat shell. In the following, the various embodiments will be mentioned separately or referred to collectively as “means of impeding”.

A core idea of the invention is to provide at least one means of impeding (or making it impossible or preventing) the side impact protector to be transferred into the rest position or to be or remain in the rest position. Such a means of impeding can, for example, be formed by an actuating device (for example for releasing a lock of the functional position or for setting a latching of the rest position, cf. the first and/or second latching devices defined further below), which is spaced apart from the side impact protector (or in particular a side element of the side impact protector, described in further detail below) in at least one position of the latter (preferably in at least the functional position, possibly at least in the rest position, according to the embodiment both in the functional as well as in the rest position).

An actuating device for releasing such a lock, which is arranged directly at (or on) the side impact protector (or its side element), is in particular not intended to be understood as such a means of impeding. Preferably, such an actuating device for releasing or adjusting the lock has a distance of at least 0.5 cm from the side impact protector or side element and/or is at least partially covered by a cover and/or a lid, in particular a concealing one. Alternatively or additionally, the actuating device can be actuated only from a position remote from the side impact protector, in particular the side element (for example from an inner side of the seat shell if the side impact protector, in particular the side element, is attached or attachable to an outer side of the seat shell).

A means for impeding a movement into the rest position may generally comprise a (at least partial) covering of an actuating device for releasing a lock of the functional position, for example a covering cover and/or an at least partially covering cushion and/or an at least partially covering separate (possibly rigid or flexible) cover element. Any measure which prevents that the user (alone) by an actuation (directly) at the side impact protector (or the side element) itself (without reaching behind and/or at least partially removing a cover) can be considered as such a means of impeding a movement into the rest position.

By an impeding (or preventing) of a permanent setting of the rest position it should be understood in particular that the child seat is configured in such a way that it is only possible (or not possible) (without the action of external forces) to fix, in particular to maintain, the rest position with structures and elements of the child seat itself only with difficulty, for example by actuating a (separate) corresponding actuating device. By a fixing of the rest position, it is to be understood in particular that the side element, at least in the case of a small force (of, for example, 1 N) acting in the direction of the functional position, is not moved out of the rest position.

In any case, by such a means the operation is improved in terms of safety, in particular the risk of a misuse or a missing or incorrect setting (in the functional position) is reduced. These ideas are contrary to previous solutions, which are aimed precisely at being able to release a (possibly locked) functional position in a simple manner, e.g. by measures that can be carried out on or directly at the side impact protector or side element (without requiring any reaching behind or even removal of blocking structures). This path suggested by the prior art is now deliberately abandoned and, in the form of the means of impeding, a measure is taken which contrary to the usual approach (which aims at user comfort, especially when it comes to releasing a lock or the like) to keep as high as possible.

According to the invention, preferably the transfer to the resting state is impeded. Alternatively or additionally, a latching (fixing) of the rest position can be impeded, whereby preferably at the same time a position transfer device (explained further below) for automatic transfer from the rest position to the functional position is present.

According to a general idea, it should be impeded to bring the seat into a configuration in which the rest position (permanently or without external influence) is assumed, for example in that the release of the functional position is impeded and/or the transfer from the functional to the rest position is impeded, for example because a blocking means only permits a partial transfer (wherein in this context particularly preferably a position transfer device for automatic transfer to the functional position is present) and/or the latching of the rest position is impeded (whereby here also a position transfer device for automatic transfer to the functional position is present).

In embodiments, in particular with foldable and/or extendable side protection, preferably a position transfer device for at least partially automatic transfer of the side impact protector from the rest position to the functional position is provided. The position transfer device can support the transfer from the rest position to the functional position at least in sections (automated). The position transfer device preferably has at least one spring.

By impeding in particular an increased effort for the user or a lower probability of performing the (respective) action incidentally, unconsciously and/or by mistake is to be understood. This can be arranged, for example, by a hidden arrangement of an actuating device (of an operating element) and/or a covered arrangement (in particular covered by a cover) of an actuating device (of an operating element) and/or an arrangement of an actuating device (of an operating element) remote from the side impact protector (or side element), for example with a side impact protector or side element on an outer wall section of the seat shell and an actuating device (an operating element) at least approximately on a complementary inner wall section, and/or an arrangement of an actuating device (of an operating element) in an inner area and/or receptacle area of the child seat or on a contact surface of the child, in particular in such a way that it is concealed by the child or the space for operating the element is greatly reduced by the child.

In principle, various implementations (also shown below with further details) are possible.

A fold-out side element with a position transfer device may be present, whereby a latching in the rest position is impeded.

A fold-out side element may be present, whereby a release of a locked or latched functional position is impeded.

An at least partially displaceable, in particular telescopic, side element with a position transfer device may be present, whereby a latching of the rest position is impeded.

An at least partially displaceable, in particular telescopic, side element may be present, whereby a release of the latched or locked functional position is impeded.

A side element which can be displaced by screwing (e.g. can be screwed in and/or out) may be present with a position transfer device, whereby a latching of the rest position is impeded.

A side element which can be displaced by screwing (e.g. can be screwed in and/or out) may be present, whereby a release of the latching of the functional position is impeded.

A detachable or removable side element may be present, whereby a release of the latched or locked functional position is impeded.

According to the embodiment, the object is further solved by a child seat for mounting on a motor vehicle seat (for example of a car or truck), the child seat having: a seat shell, a side impact protector which is attached to the seat shell and is arranged between a resting position, in particular located within a predetermined width (for example, a standard width), and a functional position, in particular located outside the predetermined width, and a position transfer device for the at least partial (possibly complete) automatic transfer of the side impact protector from the rest position into the functional position, wherein the side impact protector cannot or at least not exclusively by a complete transfer from the functional position into the rest position be locked (in the rest position).

One idea is therefore to configure the child seat or its side impact protector in such a way that a (complete) transfer from the functional position to the rest position does not (alone) result in the side impact protector or the rest position thereof being locked. However, this does not necessarily mean that the side impact protector cannot be locked in the rest position (e.g. by means of a separate locking device). Preferably, locking is possible.

Unless explicitly stated otherwise, a possible locking of the rest position shall not be part of the transfer from the functional to the rest position. On the other hand, unless explicitly stated otherwise, a locking of the functional position should be part of a complete transfer from the rest position to the functional position.

It is deliberately deviated from the prior art, in which the locking of the rest position takes place automatically (e.g. by snapping in a latching mechanism) upon complete transfer to the rest position. This approach in the prior art is also initially obvious, as this simplifies the operation of the child seat or its side impact protector.

According to the invention, however, it has been recognised that the deliberate abandonment of such a (initially user-friendly appearing) solution results in the side impact protector, and thus the child seat, being improved from a safety point of view. If, for example, the side impact protector is unconsciously or unintentionally transferred to its rest position, but it is not locked by that, it is transferred (driven) back to the functional position (or towards the functional position) due to the position transfer device.

Even a deliberate transfer (e.g. only temporarily, in order to better reach an area that is blocked by the side impact protector in the functional position, or also over a longer period of time, for example during stowage) does not (alone) lead to the fact that the rest position is maintained (locked), but (on the contrary) the side impact protector is then configured in such a way that it (as soon as no external force acts any more, which counteracts the position transfer device) is transferred again into the functional position (or direction thereof). In this way, risks resulting, for example, from forgetting the transfer back to the functional position (for example, in a case where the child seat is re-installed in the motor vehicle from a parking area) can be reduced. Furthermore, it is achieved that a locking is (at least with higher probability) intentional and deliberate (if a separate operation is necessary to realise the locking, in particular if a separate first actuating device has to be actuated to realise the locking in rest position). Overall, the safety is improved by that.

In embodiments, in particular with attachable side impact protector (but possibly also with foldable or extendable side impact protector, the means of impeding is preferably configured to impede a release of the (locked) functional position.

In embodiments, the means may be configured to impede a transfer into the rest position, for example to allow only a partial transfer to the rest position (or to allow a complete transfer to the rest position only if a corresponding manual actuating device is actuated, which then possibly allows to fully transfer the side impact protector or the side element to the rest position).

The “child seat” is preferably any type of child seat for mounting on a motor vehicle seat, in particular a baby shell (possibly with a carrying handle) or a child seat (which may not be a baby shell and/or which is designed without a carrying handle). The child seat may or may not be adaptable to children of different sizes.

The “child” is preferably a human being between 0 and 14 years, possibly 0 and 8 years, and/or a human being with a height between 30 and 140 cm, possibly between 40 and 120 cm or between 50 and 105 cm, preferably a baby or a child (who is not a baby).

Under a “positional transfer” is preferably to be understood a change of the position and not any change of state, such as a change of shape due to inflation.

During the position transfer, the shape of the side impact protector (or at least the side element as defined further below) preferably does not change.

The seat shell preferably comprises the (all) parts of the child seat through which a child is received—at least in sections. The seat shell comprises a seat section and may optionally also comprise a back section, wherein the back section may comprise a headrest which may optionally be adjustable to the size of the child, for example in size and/or position. The seat shell preferably has, at least in sections, side walls that provide lateral support to the child. The side walls may at least in sections be components of the seat section and/or the back section. The seat shell may be formed in one or more parts, and it can possibly be formed adjustably (for example with regard to an angle between the seat section and the back section). Furthermore, the seat shell may comprise a padding. Particularly in the case of baby shells, it may also be that the seat shell comprises an outer shell which does not form an immediate seating and/or an immediate backrest, but that the seat section of the seat shell comprises an independent seating element which is arranged in the outer shell and may be adjustable and/or that the back section of the seat shell comprises an independent backrest which is arranged in the outer shell and may be adjustable (or else that the seating and the backrest are formed by the seat shell). The seat shell preferably structurally defines the receptacle space for the child and delimits it. For child seats comprising a base for mounting on the motor vehicle seat and a main body for mounting on the base, the base may be part of the seat shell at least in sections, in particular if the base structurally reinforces sections of the main body.

A back support surface is preferably the section of the child seat intended to lay-on the back of a child received in the child seat. The back support surface is preferably at least substantially in one plane or is not or at least only slightly curved. Support surfaces for the sides of the child are preferably not to be understood as components of the back support surface.

Preferably, the predetermined width is a width (lateral extent) predetermined by a specific configuration of the child seat (e.g. adaptation to a specific size of a child) when the side impact protector is in the rest position. Preferably, the predetermined width shall be defined by the width of the child seat without taking into account the side impact protector (in particular by the width of the seat shell), but if necessary, the predetermined width may also be (at least slightly) larger than the width of the child seat without taking into account the side impact protector, in particular (at least slightly) larger than a width of the seat shell, if the side impact protector in rest position exceeds such a width or the seat shell (preferably, however, by at most 2 cm, further preferably by at most 1 cm).

The predetermined width is preferably at least 40 cm, further preferably at least 42 cm and/or at most 80 cm, preferably at most 60 cm, optionally at most 50 cm. In embodiments, the predetermined width is between 40 and 50 cm, preferably 42 to 47 cm, in particular at (at least approximately) 44 cm.

Preferably, in the functional position in the event of a side impact, the (maximum) width of the child seat is defined by the side impact protector. In the rest position of the side impact protector, the (maximum) width of the child seat can be defined either by the side impact protector or, preferably, another component of the child seat (or both, if in this position the side impact protector extends as far in the width or side direction as the child seat without taking into account the side impact protector).

Preferably, the side impact protector in the functional position extends at least 3 cm, preferably at least 5 cm, possibly at least 10 cm and/or at most 20 cm further in the lateral direction (or width direction) than in its rest position.

When the side impact protector (or, if provided, all side impact protectors of a plurality of side impact protectors) is (are) moved to its (their) rest position, a (maximum) width of the child seat shall preferably be at least 5%, preferably at least 15% less compared to a (maximum) width of the child seat when the side impact protector (or all side impact protectors) is (are) in its (their) functional position.

Preferably, the side impact protector shall be transferable between rest and functional positions independently of any adjustments of the child seat to the size of the child.

Under a (only) partial transfer of the side impact protector from the rest position to the functional position it should in particular be understood that the side impact protector can be transferred from an intermediate position between rest position and functional position to the functional position (or a further intermediate position between rest position and functional position which, however, is closer to the functional position than the first intermediate position). Particularly preferably, however, the position transfer device is designed to transfer the side impact protector completely from the rest position (if necessary after a preferably small movement for de-latching) into the functional position.

The functional position is preferably lockable (in particular with respect to a transfer into the rest position, e.g. a folding or pushing in or a detaching or removal). Alternatively or additionally, the rest position can be locked (in particular with respect to a transfer into the functional position, e.g. an unfolding or pushing out or pulling out). Under a locking it is to be understood in particular that the side impact protector is blocked with regard to its transfer (from the functional to the rest position or vice versa), i.e. such a transfer (e.g. folding or pivoting or displacement, possibly removal) is blocked (latched). Locking can mean that the side impact protector cannot move at all (until the locking is released). However, a lock can also be provided in that only the transfer process for transferring to the respective other position is blocked (i.e. for example, in the case of a foldable and/or pivotable side impact protector, a corresponding folding and/or pivoting is blocked), but a movement that does not imply such a transfer is still allowed. For example, a foldable and/or retractable/pushable side impact protector can be locked in the functional position in such a way that a folding and/or a pushing-in is blocked, but another movement (e.g. outwards, in particular by pulling on the side impact protector) is allowed (in particular to release the locking). Analogously, a, for example, foldable and/or extendable side impact protector can still be movable to a limited extent in the (locked) rest position (wherein this movement can also be used here to release the locking if necessary). Furthermore, a, for example, foldable side impact protector can still be movable translationally in the (locked) rest position (whereby this movement can also be used here to release the locking if necessary). Thus, a locking should in particular mean that the transfer or transfer movement as such is blocked or latched (but not necessarily any freedom of movement of the side impact protector).

In embodiments, the side impact protector comprises or consists of a side element. There may be exactly one side impact protector (side element) or (preferably) at least or exactly two side impact protectors (side elements), preferably at least one or exactly one on each side of the child seat. The (respective) side impact protectors are preferably independently of each other transferable from the rest position to the functional position and/or vice versa.

In preferred embodiments, the respective side impact protector comprises or is formed at least in sections (further preferably in its entirety) by a pivotable and/or foldable side element.

Alternatively or additionally, the side impact protector may comprise or be formed by a side element which is (translationally) displaceable (e.g. can be pulled in or pulled out and/or can be pushed in or out) at least in sections (possibly in its entirety). For example, the side element can have a telescopic design (possibly in such a way that, for example, a first section of the side element can be displaced relative to a second section of the side element and the second section in turn can be displaced—preferably together with the first section—relative to a third section of the side element and/or relative to the seat shell).

The side impact protector or its side element can also be pivotable and/or foldable in sections and be displaceable (translationally) in sections (for example in a second section). It would also be conceivable that the side impact protector is both (in its entirety) pivotable and/or foldable as well as (in its entirety) displaceable.

Insofar as various movements of the side impact protector are mentioned above and below, this is preferably intended to mean movements which mean a (at least partial, preferably complete) transfer of the side impact protector from the rest position to the functional position (or vice versa). For example, a side element should also be able to be understood as a foldable side element if a section thereof is displaceable for other reasons (for example, for locking purposes), for example, comprises a push button (for example, if a side element that is foldable per se is also intended to be displaceable, for example in its entirety, but in order to establish and/or release a locking, but in particular not in order to carry out a transfer movement into the respective other position). However, other things may result from the context.

In preferred embodiments, the side impact protector is not or at least not exclusively lockable by a (complete) movement thereof into the rest position. Alternatively or additionally, a (the) side element of the side impact protector is not or at least not exclusively lockable by a (complete) movement thereof into the rest position.

Preferably, the rest position of the side impact protector or the side element (in particular in its entirety) shall not be lockable solely by the respective movement (of the entire side impact protector or the entire side element). This can (but generally should not) exclude that the side impact protector or the side element, or a respective section for locking can be moved relative to a respective other section of the side impact protector (or side element) or the seat shell in such a way that a locking (in the rest position) takes place. Insofar as a locking in the rest position is possible, this should preferably only be able to take place by movement (actuation) of a device which is not part of the side impact protector (or at least not part of the side element), further preferably by movement (actuation) of a device which does not move with the side impact protector (or its side element) during the transfer between rest and functional position or vice versa. Alternatively, the device for locking of the rest position can be part of the side impact protector (or the side element) and/or move with it, but cannot be accessed directly or from the outside of the seat shell in the rest position.

A first locking device may be provided to lock the rest position (or the side impact protector and/or side element in the rest position). A second locking device can be provided for locking the functional position (or the side impact protector and/or its side element in the functional position). Insofar as both first as well as second locking devices are provided, they may be implemented entirely (or only in sections) by common structures. However, according to the embodiment, first locking device and second locking device are provided by different structures (i.e. separately from each other).

The first locking device can preferably assume a locking position (in which the side impact protector or the side element is held in its rest position) and a non-locking position (in which a transfer of the side impact protector or the side element into the functional position is possible). According to the embodiment, the transfer of the first locking device into the locking position is not (alone) triggered by a transfer of the side impact protector (or the side element) into the rest position.

According to the embodiment, the functional position of the side impact protector can be lockable (alone) by a (complete) transfer of the side impact protector into the functional position. However, it would be conceivable here also that a locking can only be made possible by actuating a (separate) second actuating device.

The child seat preferably has a (particularly manual) first actuating device for triggering (or setting) a (the) locking of the rest position. The first actuating device preferably comprises a knob and/or slider and/or lever. The first actuating device may not be accessible (or may be difficult to access) when a child is accommodated in the child seat. For example, the first actuating device may be covered (in normal use) by a part of the child's body.

The first actuating device may alternatively or additionally be covered, for example by a cover and/or padding.

The first actuating device may alternatively or additionally comprise at least two operating elements to be actuated, in particular in such a way that a locking of the rest position (of the same side impact protector or side element) is only made possible if both operating elements are actuated simultaneously and/or overlapping in time and/or one after the other. Insofar as reference is made here, above and below to an actuating device and/or an operating element, a manual actuating device or a manual operating element shall always preferably meant (unless the context indicates otherwise).

The first actuating device may alternatively or additionally be separated from the side impact protector and/or a (the) side element thereof by at least one separating structure, in particular a separating wall, preferably a wall of the seat shell. The separating structure, in particular separating wall, can be holed-out if necessary, for example to allow the movement of a latch.

The first actuating device may alternatively or additionally have a distance of preferably at least 1 cm, further preferably at least 3 cm, further preferably at least 6 cm to the side impact protector and/or a (the) side element thereof.

The first actuating device may alternatively or additionally not be visible from the outside (with viewing direction towards an outer wall of the child seat) and/or from the inside (with viewing direction towards an, in particular, padded inner wall of the child seat). If necessary, the first actuating device may not be visible at all (without being actively uncovered by the user, for example by lifting and/or swivelling a padding).

According to the embodiment, the first actuating device can be provided (arranged) on an inner side of the seat shell and/or be accessible (only) from there, possibly at least partially below a padding and/or a fabric cover. Alternatively or additionally, the first actuating device can be provided on an outer side of the seat shell, preferably at least partially concealed by a padding and/or a (particularly cushion-like) shock absorber and/or a cover.

The first actuating device may be actuable against the force of a resilient biasing means.

The first actuation means may optionally drive a latch which or part of which is provided for engagement with an engagement structure of the side impact protector or side element.

The child seat further comprises in embodiments a (particularly manual) second actuating device for releasing a (the) locking of the functional position. The second actuating device preferably comprises a button and/or slider and/or lever. The second actuating device may not be accessible (or may be difficult to access) when a child is accommodated in the child seat. For example, the second actuating device may be covered (in normal use) by a part of the child's body.

The second actuating device may alternatively or additionally be covered, for example by a cover and/or padding.

The second actuating device may alternatively or additionally have at least two operating elements to be actuated, in particular in such a way that a release of the functional position (of the same side impact protector or side element) is only made possible if both operating elements are actuated simultaneously and/or overlapping in time and/or one after the other.

The second actuating device can alternatively or additionally be separated from the side impact protector and/or a (the) side element thereof by at least one separating structure, in particular separating wall, preferably wall of the seat shell. The separating structure, in particular separating wall, can be holed-out if necessary, for example to allow the movement of a latch.

The second actuating device may alternatively or additionally have a distance of preferably at least 1 cm, further preferably at least 3 cm, further preferably at least 6 cm to the side impact protector and/or a (the) side element thereof.

The second actuating device may alternatively or additionally not be visible from the outside (with a view direction towards an outer wall of the child seat) and/or from the inside (facing a particularly padded inner wall of the child seat). If necessary, the first actuating device may not be visible at all (without being actively uncovered by the user, for example by lifting and/or swivelling a padding).

According to the embodiment, the second actuating device can be provided (arranged) on an inner side of the seat shell and/or be accessible (only) from there, possibly at least partially below a padding and/or a fabric cover. Alternatively or additionally, the second actuating device can be provided on an outer side of the seat shell, preferably at least partially concealed by a padding and/or a (particularly cushion-like) shock absorber and/or a cover.

The second actuating device may be actuable against the force of a resilient biasing means.

The second actuation means may optionally drive a latch which or part of which is provided for engagement with an engagement structure of the side impact protector or side element.

In embodiments, the second actuating device may be identical to the first actuating device, but generally this is not the case.

The side impact protector may comprise or be formed by a side element which is displaceable (at least in sections, possibly in its entirety).

The side impact protector may comprise a side element which is removable at least in sections (in particular completely). In such a case, the functional position is to be understood in particular as a position in which the side element is attached, in particular plugged, in or on a corresponding receptacle (in particular recess) of the seat shell. As a rest position is then to be regarded in particular a position in which the side element is not attached in this way (or plugged in, at least not in the same place as in the functional position), but is accommodated in a different place (but preferably in such a way that the lateral dimensions of the child seat are at least not substantially increased in this accommodation). For example, a rest position may be considered to be a position of a removable side element in which the side element is resting on the seating (in particular in a state of the child seat in which it is not being used but is, for example, being stored). If necessary, a rest position receptacle for the side impact protector (the side element) can also be provided on the child seat, or the side impact protector (the side element) can be received rotated, for example by 90° or by 180°, in the receptacle also provided for the functional position. A rest position can also be present if the side element is accommodated in a different place than the child seat, for example stowed away. In this respect, a child seat designed in this way can also be considered as a system comprising a (fully functioning) basic child seat as well as, in addition, at least one side element of a side impact protector system which can be attached to and removed from this basic child seat.

The (preferably entire) side impact protector (or a component thereof) and/or its (preferably entire) side element (or a component thereof) may, in embodiments, be transferable from the functional position to a non-locked rest position by a first movement thereof and be lockable in the rest position by a second movement thereof (preferably not continuing the first movement). The second movement is preferably a movement by which the (preferably entire) side impact protector (or a component thereof) and/or its (preferably entire) side element (or a component thereof) is brought into a form-fit with a section of the seat shell, for example with an undercut and/or a projection and/or a recess thereof.

Preferably, the first movement comprises (or can be realised by) a (pure) rotation and the second movement comprises (or can be realised by) a (pure) translation. Alternatively, the first movement may comprise (or may be realised by) a (pure) translation and the second movement may comprise (or may be realised by) a (pure) rotation. Alternatively, the first movement can comprise (or be realised by) a (pure) rotation and the second movement can comprise (or be realised by) a (pure) rotation. Alternatively, the first movement may comprise (or thereby be realised) a (pure) translation and the second movement may comprise (or thereby be realised) a (pure) translation.

In particular, when the first and second movements each comprise a rotation, or when the first and second movements each comprise a translation, an axis of movement of the first movement is preferably non-parallel, further preferably at an angle of at least 30°, further preferably at least substantially perpendicular to an axis of movement of the second movement. Such a non-parallel design of the axis of movement makes it (deliberately) difficult in a simple manner for an action that leads to a transfer to the rest position to also (possibly unintentionally) result in a locking of the rest position. An axis of movement is preferably understood to be an axis of rotation in the case of rotation and in the case of translation a straight line, parallel to which the side impact protector or the side element moves.

In one embodiment, the side impact protector may comprise or be formed by a side element (in particular the above) which can be pivoted and/or folded at least in sections for at least partial transfer into the rest position, wherein a locking of the rest position can be performed by displacing the side element and/or a component thereof. For example, the side element (in rest position, in particular after a folding) can still be translationally displaced in such a way that it is brought into a corresponding recess (for example formed by an undercut) of the seat shell (or outer wall of the seat shell) and is then held by this recess (this undercut).

Preferably, the child seat comprises a seat section (for receiving the child's buttocks and leg) and a back section (for leaning-on the child's back). Particularly preferably, the side impact protector is arranged or arrangeable (in particular attached or attachable) in the back section of the child seat, in particular at the rear of a back support surface, and/or above the seat section of the child seat. Alternatively or additionally, the side impact protector can be arranged or arrangeable (attached or attachable) on an outer side of the child seat (or seat shell). Particularly preferably, the side impact protector is arranged or arrangeable (attached or attachable) on an outer side of a side area of the seat shell.

Specifically, a (the) side element(s) (of the side impact protector) can be designed as an arm projecting to the side in the functional position, preferably extending at least substantially horizontally and/or (at least substantially) perpendicularly to the surrounding surface of the seat shell.

The position transfer device may comprise at least one spring (e.g. compression and/or tension spring) to effect the position transfer. The spring may be preloaded in rest position (or in an intermediate position between rest and functional position) so that it relaxes at least partially, possibly completely, upon transfer to the functional position.

When the side impact protector is (manually) transferred to its rest position, should preferably a locking in the rest position should not necessarily occur. In other words, a (complete) transfer to the rest position (alone) should preferably not trigger a locking of the side impact protector, so that (without the action of an external force, e.g. a holding force applied by a user, the side impact protector is again—at least partially—transferred to the functional position by the position transfer device).

The side impact protector may comprise a (the) side element, wherein the transfer of the side impact protector between rest position and functional position may preferably be effected by folding or pivoting the side element.

The side element can have a proximal end, which in the functional position of the side impact protector forms a section of the side element closest to the receptacle space for the child, and a distal end opposite the proximal end, which in the functional position of the side impact protector is further away from the receptacle space or from the seat shell (in particular in the lateral direction) than the proximal end. Preferably, the distal end forms the most laterally outwardly protruding section of the child seat when the side impact protector is in the functional position. The side element may at the proximal end (or in its vicinity) be mounted foldably or pivotably, in particular about an (preferably aligned at least substantially perpendicular to the lateral direction and/or at least substantially vertical) axis, to the seat shell.

The side element can preferably abut flatly against the seat shell in the rest position and/or be fully or partially embedded in the seat shell. For this purpose, a recess can be formed in the seat shell, if necessary, which can accommodate the side element completely or in sections. Additionally or alternatively, the area of the seat shell in which the side impact protector is provided can be formed as a support section. An abutting flatly is preferably intended to imply a direct abutting or an abutting with a small distance (e.g. at most 2 cm, preferably at most 1 cm).

In the rest position, at least 10%, preferably at least 25% of the surface of the side element may be at a distance of preferably less than 2 cm, further preferably less than 1 cm, from the child seat (in this consideration without side element), in particular from a surface (outer surface) of the seat shell.

The first actuating device (the actuating element) may comprise (or be formed by) a button, a knob, a slider (or the like). In general, the first actuating device (actuating element) may be designed for pushing, pulling and/or rotating actuation.

By an actuation of the first actuating device (actuating element) at a time when the side impact protector is in its rest position the first locking device is preferably transferred into its locking position, so that the side impact protector (the side element) is locked in its rest position.

The first locking device may further comprise a release mechanism, which is preferably formed by the side element or a part of the side element. Thereby, an actuation of the release mechanism may enable and/or trigger a transfer of the first locking device from its locking position to its non-locking position. Preferably, the first locking device is biased in the direction of its release position (alternatively or additionally in the other direction), so that an actuation of the release mechanism enables the transfer of the first locking device and (if the transfer is driven by the bias) also takes place. The bias may be provided by a (first) resilient member, wherein the (first) resilient member may comprise, for example, a tension spring, a compression spring, a leaf spring or a torsion spring (or other spring), or also an elastomeric member (elastomeric block or the like).

In an alternative to the provision of a bias (or, if necessary, in addition thereto), a coordinated design and arrangement of the side element of the side impact protector on the one hand as well as of the first locking device on the other hand can be effected in such a way that a transfer of the side element from its functional position to its rest position forces the locking device into its release position. This has the advantage that a damage to the locking mechanism and/or to the side element can be (at least continuing) avoided. If necessary, it is also possible (but not preferred) to dispense with any driven or forced transfer of the first locking device and leave it to the user to select the necessary setting in each case.

Preferably, the first actuating device (the actuation element) of the first locking device shall not be formed by the side impact protector (or at least not by its side element), but shall be designed as an independent (separate) device (element) on the seat shell and/or as a section of the seat shell. Alternatively or additionally, the first actuating device (the actuating element) is further preferably provided on an inner side of the seat shell, in particular at a location that is not accessible or only accessible with difficulty when a child is accommodated in the child seat. For example, a latch attached to the side element is possible, which pivots together with the side element, and which in the rest position of the side element is accessible from the inside of the seat shell and can be actuated for locking. In the functional position of the side element, such a latch may either not be accessible, or its movement may be blocked, or the transfer of the side element to the rest position would force the latch into the non-locking position.

For example, the first actuating device (the actuating element) may be provided in a region (or in the vicinity) of the location of the inner side closest to the side impact protector. A through hole may be provided in the seat shell for a corresponding embodiment.

The first actuating device (the actuating element) may, when actuated, drive a latch or a portion of a latch (possibly formed as a protrusion or hook) (indirectly or directly, possibly against the force of the first resilient element) to engage a (first) engagement structure of the side impact protector or the side element when the side impact protector is in the rest position. According to the embodiment, latch and first actuating device (actuating element) can be formed in one piece. The engagement of the latch (possibly protrusion or hook) with the (first) engagement structure may be achieved, in particular, in that the position transfer device drives the side impact protector in the direction of the functional position and forces the engagement structure in the direction of the latch and/or in that the first locking device is biased towards the non-locking position and forces the latch in the direction of the engagement structure. Preferably, the latch can block the space necessary to transfer the side impact protector between the rest and functional positions when the first locking device is in its locking position.

The release mechanism may comprise a release actuating device (release actuating element), which may be provided on the seat shell or on the side impact protector itself. The release actuating device may comprise or be formed from a button, a knob, a slider (or the like). Generally, the release actuating device may be configured for pulling, pushing and/or rotating actuation.

Preferably, the release actuation means may be formed by the side member or a section thereof. According to an embodiment, the side impact protector or the side element can be moved (or folded or pivoted) beyond the locked rest position into a (maximum) position which, starting from the (locked or lockable) rest position, is even further away from the functional position (which thus requires a transfer in the opposite direction), so that the (first) engagement structure and the latch are moved away from each other, thereby allowing the latch to be transferred into the non-locking position by the bias. Such a maximum (in particular non-locking or non-lockable) position may also be considered as a rest position or further rest position (if it is within the predetermined width).

For example, the release actuating device (release actuating element) may be formed by a distal section of the side member, wherein the release mechanism is triggered by pushing the release actuating device towards the seat shell. However, other mechanisms such as push, slide and/or turn mechanisms (push, slide and/or turn knobs) and the like are also conceivable.

The second locking device can preferably assume a locking state (in which the side impact protector is held in its functional position) and a release state (in which a transfer of the side impact protector to the rest position is possible). The second locking device may comprise a (second) resilient element for biasing towards the locking state. The second resilient element may be formed as proposed in connection with the first resilient element.

Preferably, the side impact protector or the side element of the side impact protector (or a part thereof) can be moved (preferably sliding or gliding) into a recess provided for this purpose in the seat shell (formed, for example, by two stops) after a folding or pivoting into the functional position, thereby preferably preventing a folding back or pivoting back into the rest position. For this purpose, the side impact protector or the side element of the side impact protector (or a part thereof, e.g. a retaining part) can be biased towards the seat shell, preferably by means of the second resilient element. Preferably, the sliding or gliding may be part of the transfer to the functional position driven by the position transfer device. In this case, the position transfer device preferably forms the second locking device at least in sections. A transfer of the side impact protector back into the rest position is then possible (if necessary only) by pulling on the side impact protector or the side element of the side impact protector or the retaining part. In an embodiment, the part (the retaining part) of the side impact protector provided for sliding or gliding into the recess of the seat shell can be a slider.

The second locking device may also be implemented by other types of locking mechanisms, in particular latching mechanisms, for example by a (possibly biased) gliding and/or rotating latch, which is provided, for example, either on the seat shell to engage with a corresponding counter-structure of the side impact protector, or which is provided on the side impact protector to engage with a corresponding counter-structure of the seat shell.

In embodiments, the position transfer device may form all or part of the second locking device. Generally, the position transfer device is a device that urges the side impact protector from its rest position and/or an intermediate position towards the functional position. In particular, the position transfer device may comprise a resilient element, e.g. a tension spring, a leaf spring and/or a torsion spring, or another (suitable) spring. In this respect, reference is made in particular to DE 20 2015 104 791 U1.

Preferably, the side impact protector can be transferable from its rest position to its functional position and vice versa by folding or pivoting. In particular, the side impact protector may comprise a side element, wherein the transfer of the side impact protector between rest position and functional position may be performed by folding or pivoting the side element.

In other embodiments, however, the side impact protector can also be transferred between its rest and functional position in other ways (for example, by sliding, a telescopic mechanism or by other rotation, for example screw-like). A combination of the mentioned mechanisms is also possible.

The side element is preferably not designed as a cup holder. Furthermore, the side element is preferably not designed to (directly) support a part of the child's body or at least not as a side panel of the child seat for (directly, protector-like) protection of the side of the child.

The (respective) side element may have a (maximum) length of at least 5 cm, preferably at least 7 cm and/or at most 20 cm, preferably at most 15 cm, wherein a (maximum) length is preferably defined by the pair of points of the side element that having the greatest distance to each other. Alternatively or additionally, the length can be defined by the extension of the side element (in functional position) in lateral direction, whereby the lateral direction should again preferably represent a direction which is directed towards the side (perpendicular to the direction of view of the child looking straight ahead) or perpendicular to an orientation of the child seat (which can be from front to back and/or from back to front). A width of the side element (as a maximum extension perpendicular to the direction defined by the (maximum) length) may be at least 2 cm, preferably at least 3.5 cm and/or at most 10 cm, preferably at most 6 cm).

Furthermore, the (respective) side element may have a volume of at least 10 cm³ or at least 20 cm³ and/or at most 100 cm³.

The (respective) side element is preferably at least substantially rigid and/or dimensionally stable and/or at least substantially non-porous and/or not constructed from a honeycomb and/or not constructed from a foam.

The child seat may have a weight of at least 2 kg, optionally at least 5 kg and/or at most 20 kg, optionally at most 15 kg.

The above-mentioned object is further solved in particular by a system comprising a child seat for mounting on a motor vehicle seat (preferably a child seat as described further above and/or below), and a packaging (for example comprising a carton and/or a bag and/or a foil). The child seat preferably comprises a seat shell, a side impact protector attached to the seat shell, which is transferable between a rest position, in particular located within a predetermined width, and a functional position, in particular located outside the predetermined width, and a position transfer device for at least partially automatically transferring the side impact protector from the rest position to the functional position. The packaging and the child seat are preferably configured and arranged relative to one another in such a way that the side impact protector is held by the packaging in the rest position or in an intermediate position between the rest position and the functional position and upon removal of the packaging is at least partially (optionally completely) transferred from the rest position or from the intermediate position into the functional position by the position transfer device.

In this respect, an (independent) idea of the invention is also to package the child seat in such a way that while it is configured (in a space-saving manner) in such a way that the side impact protector is at least not completely transferred into the functional position (if applicable, is in an intermediate position in which a width of the child seat is smaller, preferably is in its rest position), but where the side impact protector is at least partially automatically transferred towards the functional position (preferably into the functional position) when the packaging is removed (or when the user unpacks the child seat).

Also by such measures safety is improved, in particular the probability is increased that the side impact protector is really used in the functional position. In this respect, the transfer to the functional position is also simplified for the user. For example, the user no longer has to look in a manual how the side impact protector can be transferred into the functional position.

Furthermore, the object is in particular solved by a method for (the) packaging of a child seat for mounting on a motor vehicle seat (preferably on a child seat as described above and/or below) and/or a method for (the) formation of a system (as described above and/or below) comprising a child seat as well as a packaging. The child seat preferably comprises a seat shell, a side impact protector attached to the seat shell, which is transferable between a rest position, in particular located within a predetermined width, and a functional position, in particular located outside the predetermined width, and a position transfer device for at least partially automatically transferring the side impact protector from the rest position to the functional position. Preferably, the child seat is packaged in such a way that the side impact protector is held by the packaging in the rest position or an intermediate position between the rest position and the functional position and, upon removal of the packaging is at least partially transferred from the rest position or the intermediate position to the functional position by the position transfer device.

The above-mentioned object is further solved in particular by a method for (un)packaging a child seat for mounting on a motor vehicle seat (preferably as described above and/or below) and/or with provision of a system (as described above and/or below) comprising a child seat as well as a packaging, and/or with provision of a according to the above method for packaging the child seat. The child seat preferably comprises a seat shell, a side impact protector attached to the seat shell, which is transferable between a rest position, in particular located within a predetermined width, and a functional position, in particular located outside the predetermined width, and a position transfer device for at least partially automatically transferring the side impact protector from the rest position to the functional position. Preferably, the packaging is removed from the child seat in such a way that the packaging does not (any longer) hold the side impact protector in the rest position or in an (the) intermediate position and the position transfer device transfers the side impact protector at least partially (optionally completely) into the functional position.

In particular, the present invention also comprises a method for packaging a child seat, wherein the child seat is configured to be mounted on a motor vehicle seat, and wherein the child seat preferably comprises a seat shell. A side impact protector, which is transferable between a rest position (in particular located within a predetermined width) and a functional position (in particular located outside the predetermined width) is attached or attachable to the seat shell. The child seat further preferably comprises a position transfer device for (at least partially automatic) transfer of the side impact protector from the rest position to the functional position. The method comprises as a first preferred step a transfer of the side impact protector from the functional to the rest position, and as a second preferred step a packaging of the child seat in such a way that the side impact protector is held in the rest position by the packaging.

The method may comprise as a further step a removal of the packaging from the child seat so that the packaging does not (any longer) hold the side impact protector in the rest position and the position transfer device (at least partially) transfers the side impact protector into the functional position. The removal of the packaging can be done, for example, by removing the child seat from the packaging.

According to an alternative idea of the invention (which is claimed alternatively and independently), the child seat for mounting on a motor vehicle can also be packaged in such a way that the side impact protector is not (completely) in its rest position, in particular (completely) in its functional position. Also then it is achieved that the safety is improved, it is in particular less likely that a (correct) adjustment of the side impact protector is omitted.

Particularly preferably, the child seat packed or to be packed according to the above is configured in such a way that in the rest position it is not (at least not necessarily) latched or locked. Then a change in the way the child seat is packed can cause the automatically acting transfer device to transfer the side impact protector at least partially towards the functional position (possibly completely into the functional position). However, even if the child seat is configured so that it is basically latched or locked in the rest position, measures can be taken in connection with the packaging of the child seat that prevent such locking. For example, the side impact protector can be placed in an intermediate position (possibly comparatively close to the rest position) in which no locking takes place or a locking mechanism can be blocked by a blocking structure (with respect to the child seat possibly external), for example by the packaging or a part thereof or a separate blocking element such as a plate-shaped element and/or an adhesive strip.

Specifically, a possible external blocking structure may be held (only) by the location/position of the side impact protector held by the packaging, so that upon removal of the child seat from the packaging, the side impact protector is (further) transferred towards the functional position and the external blocking structure is removed (e.g. falls off).

Preferably, packaging and child seat are configured in such a way that the child seat cannot be accommodated inside the packaging (at least without deforming, for example denting, or even destroying the packaging) when the side impact protector is transferred into the functional position.

The above-mentioned object is further solved in particular by a use of the child seat described above (or below), in particular in a motor vehicle for accommodating the child.

The functional features explained above and below, in particular concerning a transfer from rest position to functional position and/or vice versa, can preferably be carried out as specific process steps.

The above-mentioned object is further solved in particular by a method for configuring a child seat for mounting on a motor vehicle seat (preferably as described above and/or below). The child seat preferably comprises a seat shell, a side impact protector attached to the seat shell, which can be transferred between a rest position, in particular located within a predetermined width, and a functional position, in particular located outside the predetermined width, and a position transfer device for at least partially automatically transferring the side impact protector from the rest position to the functional position. Preferably, the side impact protector is not, or at least not exclusively, locked by a complete transfer from the functional position to the rest position (in the rest position). Particularly preferably, the side impact protector is locked in another way, further preferably by actuating a first actuating device (in particular separate from the side impact protector or at least the side element) and/or by transferring into a locking position, in particular by displacing at least a section of the side impact protector, preferably at least a section of the side element.

The child seat may alternatively or in addition to the transfer device shown above (and partly also in the figures) additionally to the at least in sections automatic transfer from the rest position to the functional position comprise a transfer device for the at least in sections automatic transfer from the functional position to the rest position. Also such a transfer device can comprise at least one spring.

Further embodiments result from the dependant claims.

In the following, the invention is described by means of embodiment examples which are explained in more detail with reference to the figures.

Hereby show:

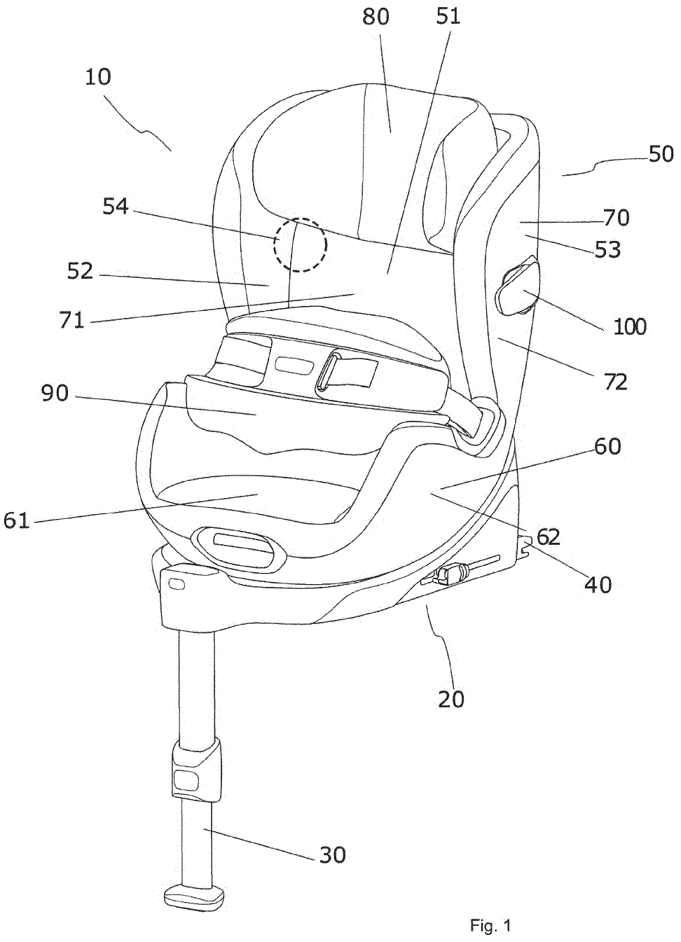

FIG. 1 a schematic oblique view of a child seat according to the invention with side impact protector in the rest position;

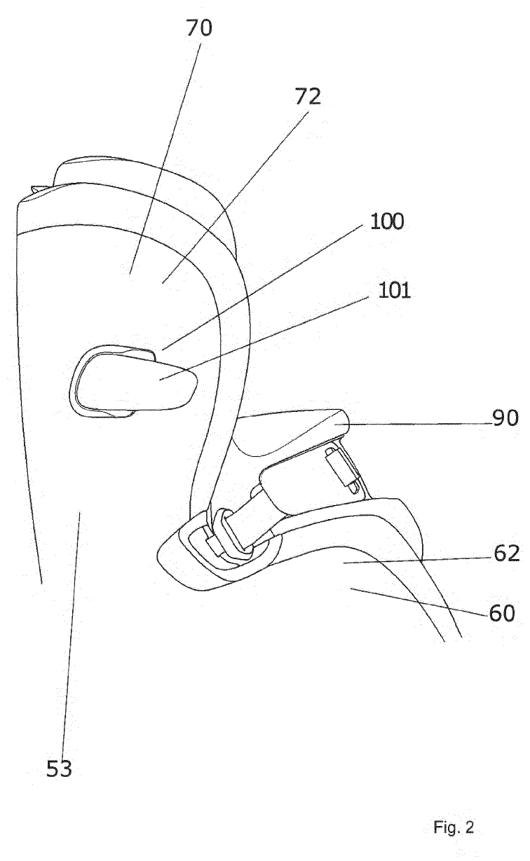

FIG. 2 a section of the child seat according to FIG. 1 in a side view;

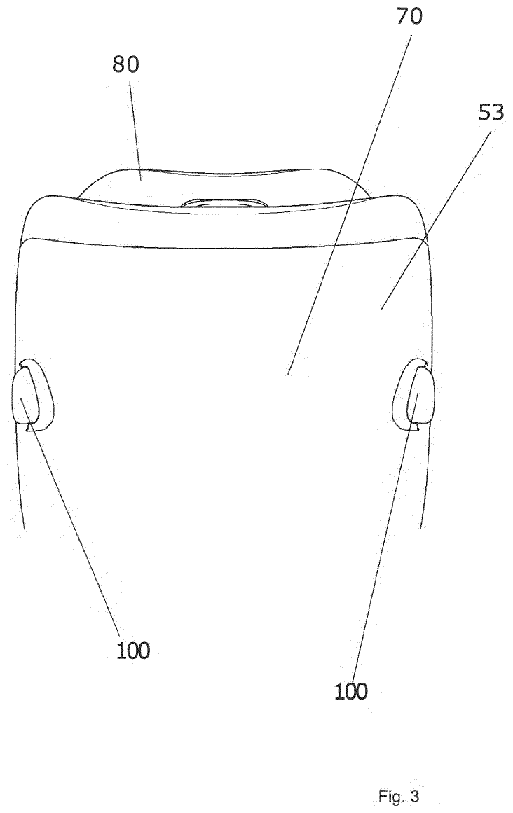

FIG. 3 a section of the child seat according to FIGS. 1 and 2 in a rear view;

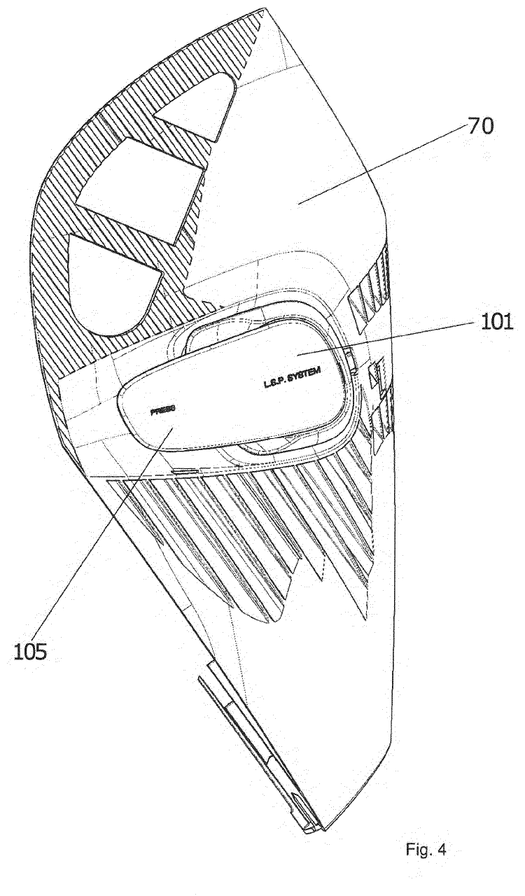

FIG. 4 a part of the seat shell of the child seat according to FIG. 1 with side impact protector in rest position;

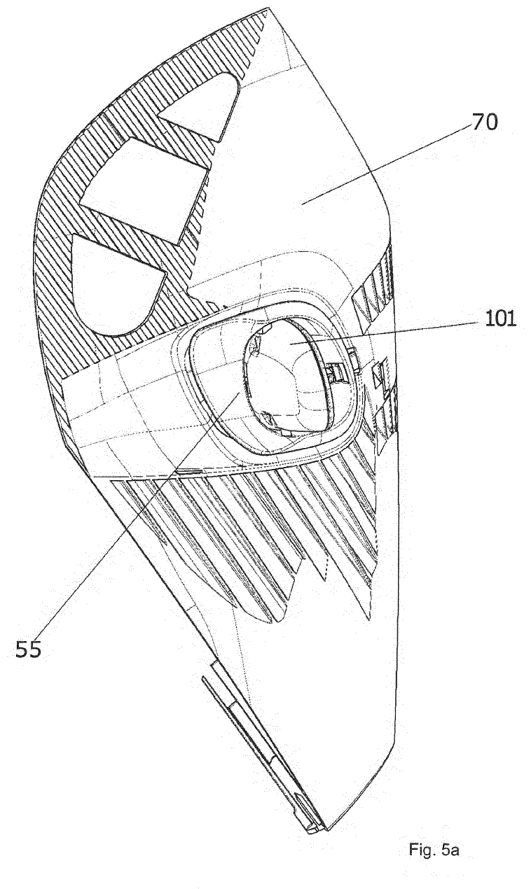

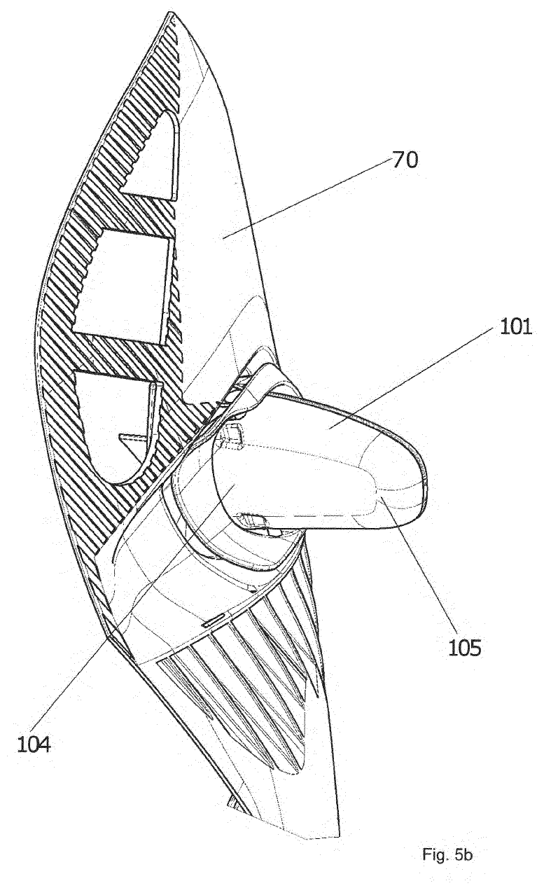

FIG. 5a the part of the seat shell according to FIG. 4 with side impact protector in functional position;

FIG. 5b the part of the seat shell according to FIGS. 4 and 5a in a different perspective with side impact protector in functional position;

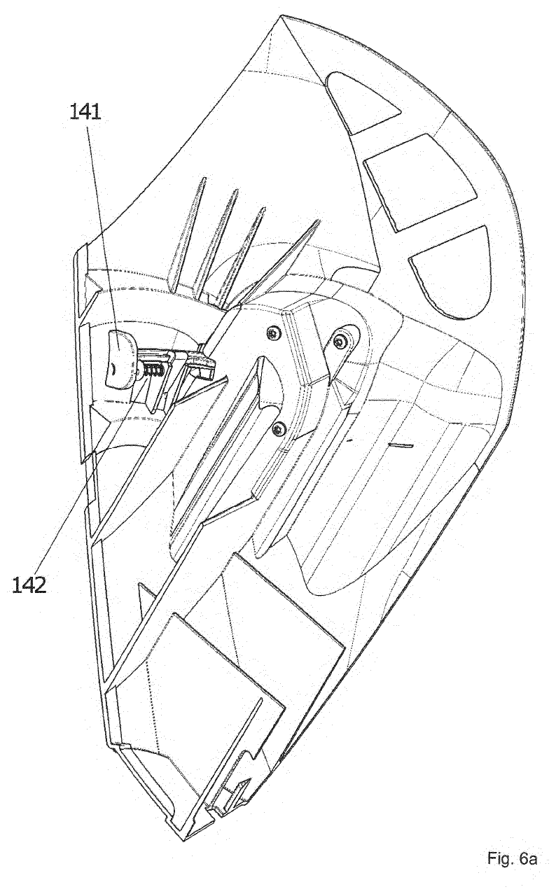

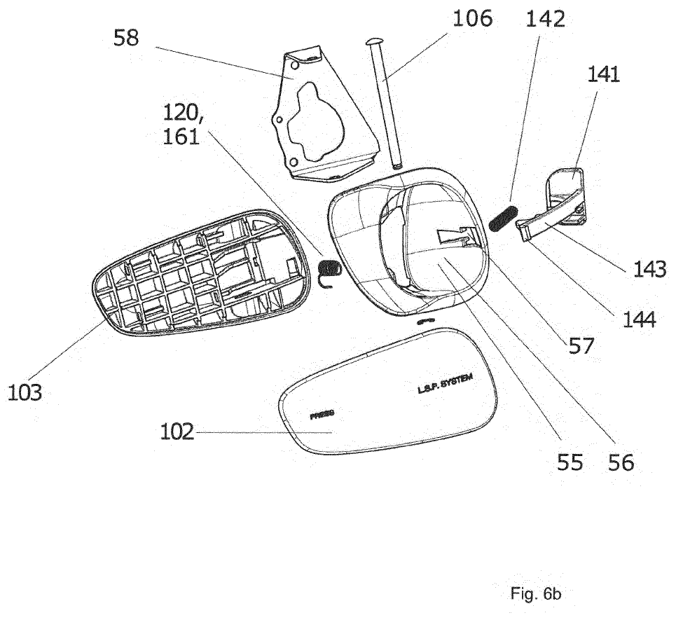

FIG. 6a a representation of a section of the seat shell from the inside (without padding/fabric cover);

FIG. 6b an exploded view of the side impact protector and a section of the seat shell;

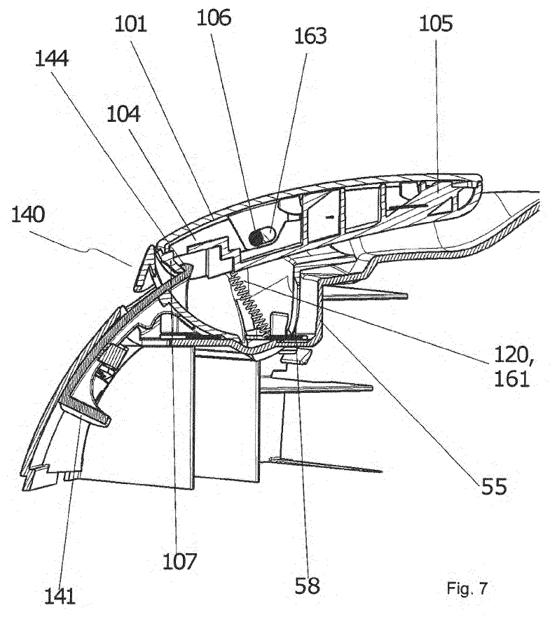

FIG. 7 a sectional view through a section of the seat shell with side impact protector in the rest position;

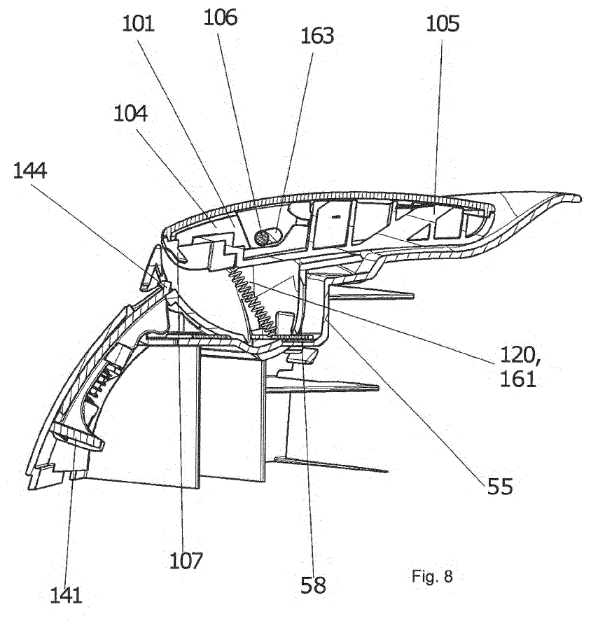

FIG. 8 a sectional view according to FIG. 7, wherein the side impact protector is moved inwards beyond the rest position;

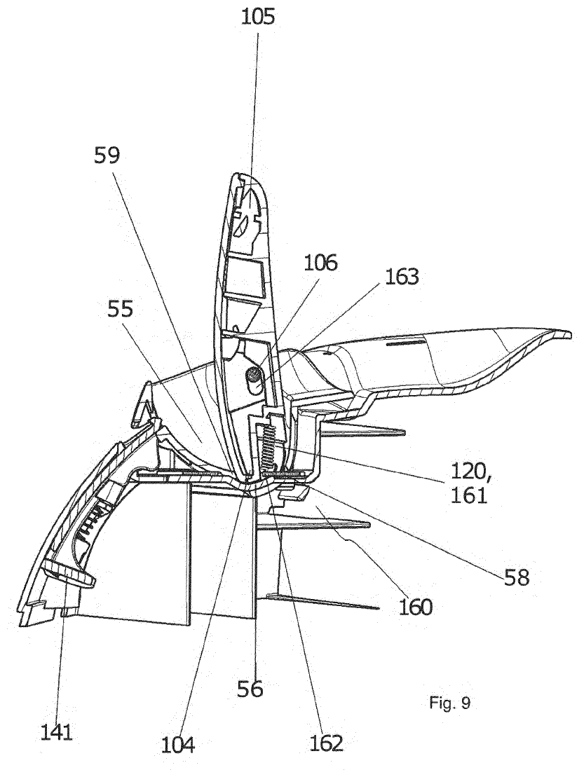

FIG. 9 a sectional view of the side impact protector according to FIGS. 7 and 8 with side impact protector in the functional position;

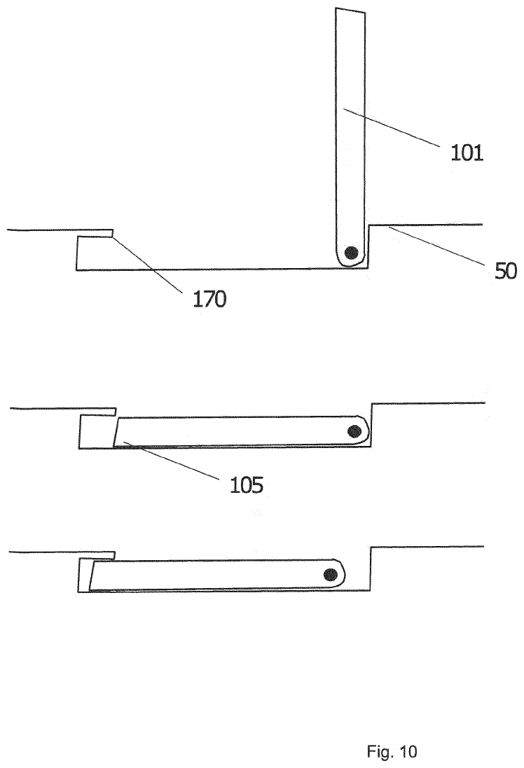

FIG. 10 an alternative embodiment of a side impact protector according to the invention in the functional position (top) as well as in the non-locked or locked rest position (middle or bottom), in each case with a section of the seat shell;

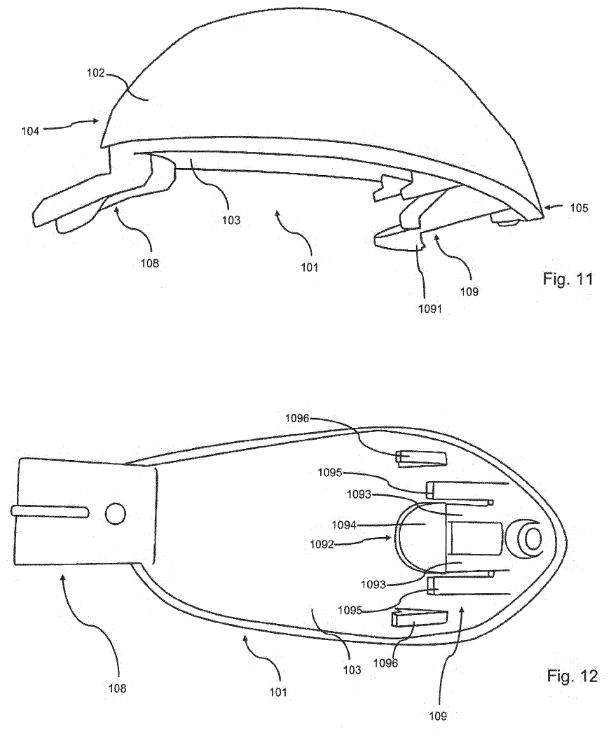

FIG. 11 a further embodiment of a side impact protector or side element according to the invention in a view from below (referring to the functional position);

FIG. 12 the side impact protector or side element according to FIG. 11 in a view from the inside (from the direction of the seat shell);

FIG. 13 a section of the seat shell with a receptacle area for the side impact protector or the side element from FIGS. 11 and 12 in an external view;

FIG. 14 approximately the section of FIG. 13 from a slightly different angle;

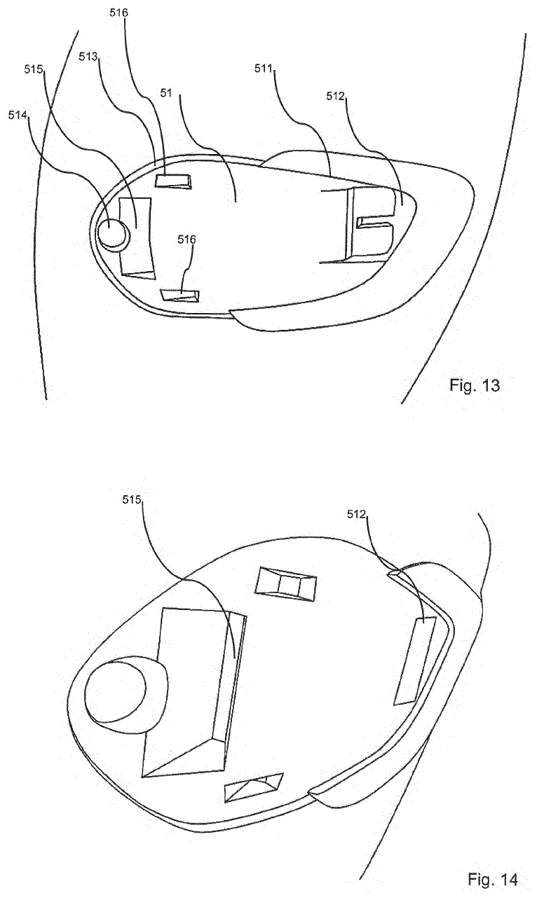

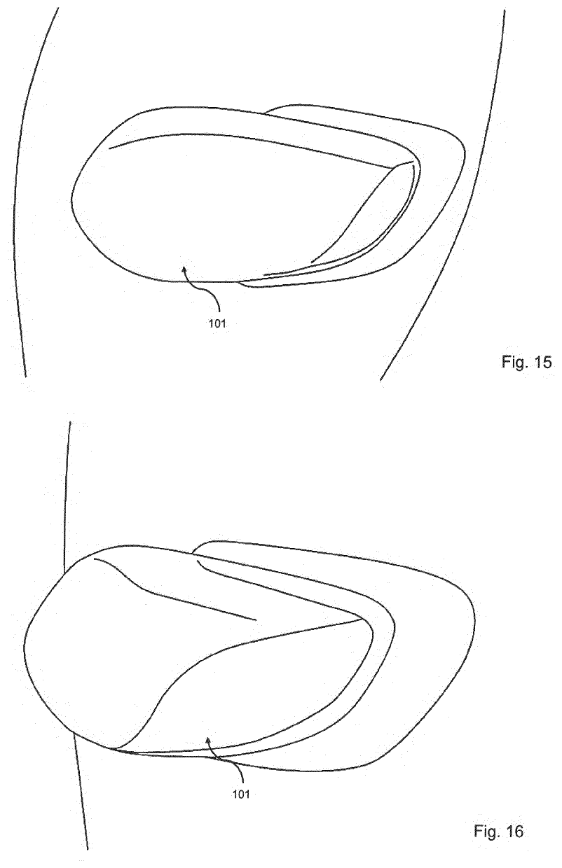

FIG. 15 the section of the seat shell according to FIG. 13, but with the side impact protector attached;

FIG. 16 approximately the section of FIG. 15 from a slightly different angle;

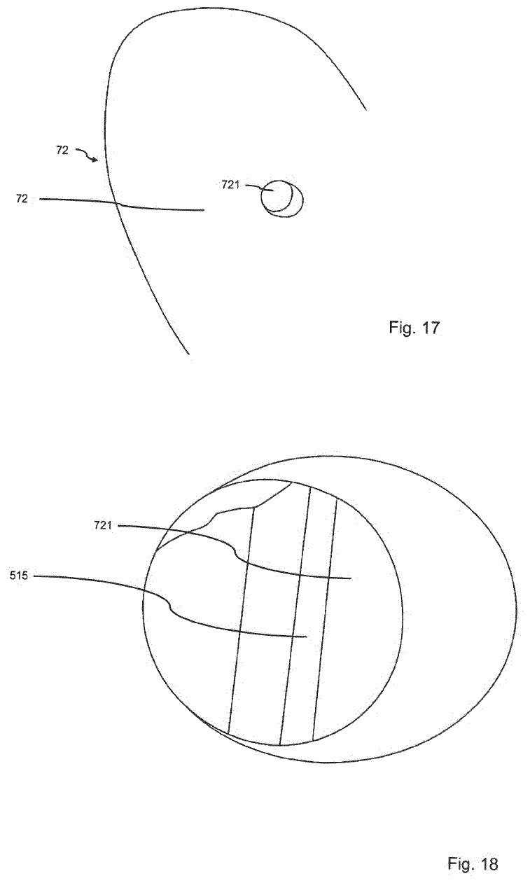

FIG. 17 a view from the inside of a side area of the seat shell;

FIG. 18 an enlarged view of the through hole according to FIG. 17 with additional details and without the side element attached;

FIG. 19 an enlarged view of the through-hole according to FIG. 17 with additional details and with the side element attached;

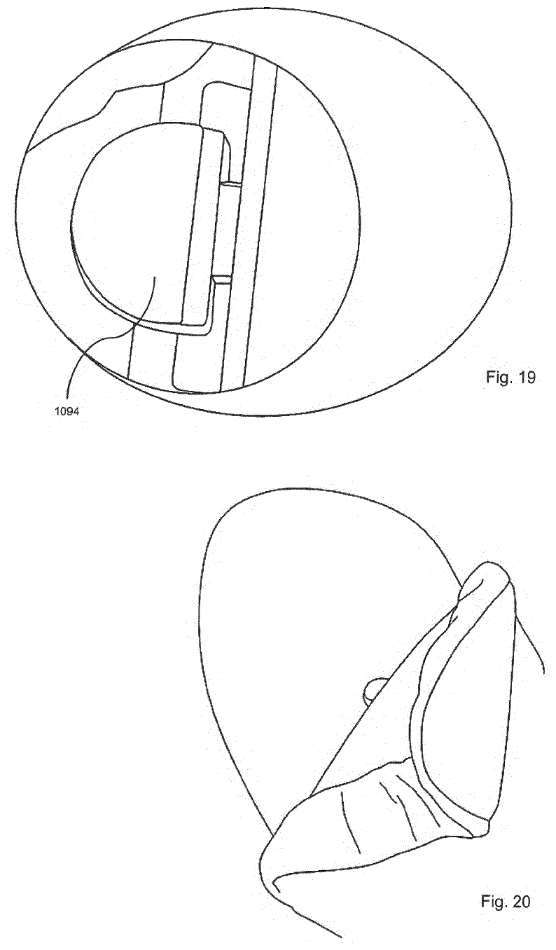

FIG. 20 a view analogous to FIG. 17 with covers shown but only partially removed;

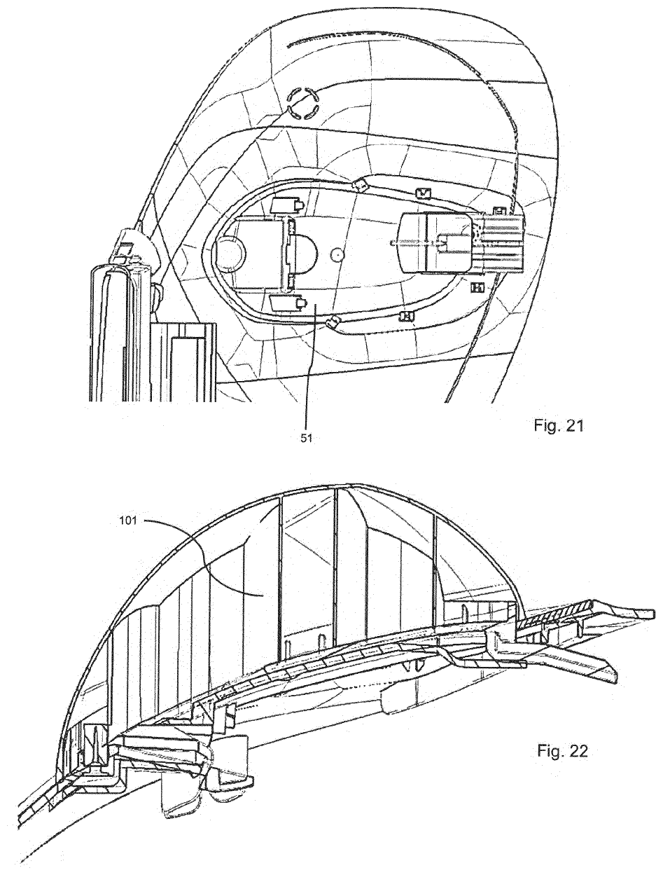

FIG. 21 a section of the seat shell with a receptacle area for the side impact protector or side element, similar to FIG. 13;

FIG. 22 a section through the seat shell according to FIG. 21 and through the side impact protector;

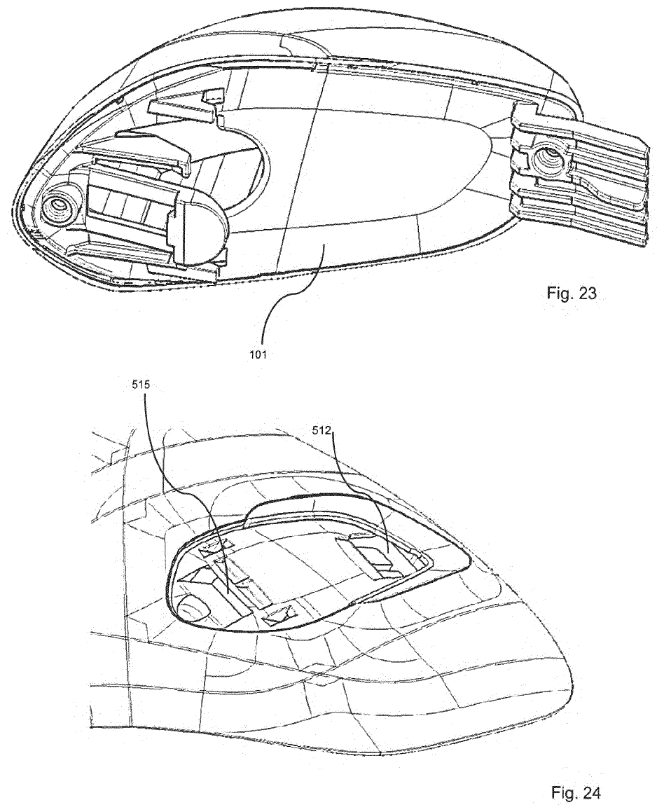

FIG. 23 the side impact protector according to FIG. 22 in a view similar to FIG. 12;

FIG. 24 the receptacle area for the side impact protector or the side element according to FIG. 21, but from a different angle of view;

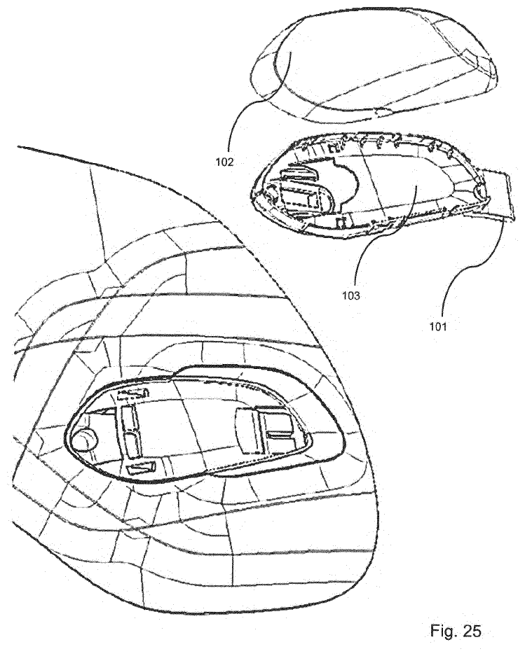

FIG. 25 an exploded view of the receptacle area according to FIG. 24 and the side impact protector according to FIG. 23;

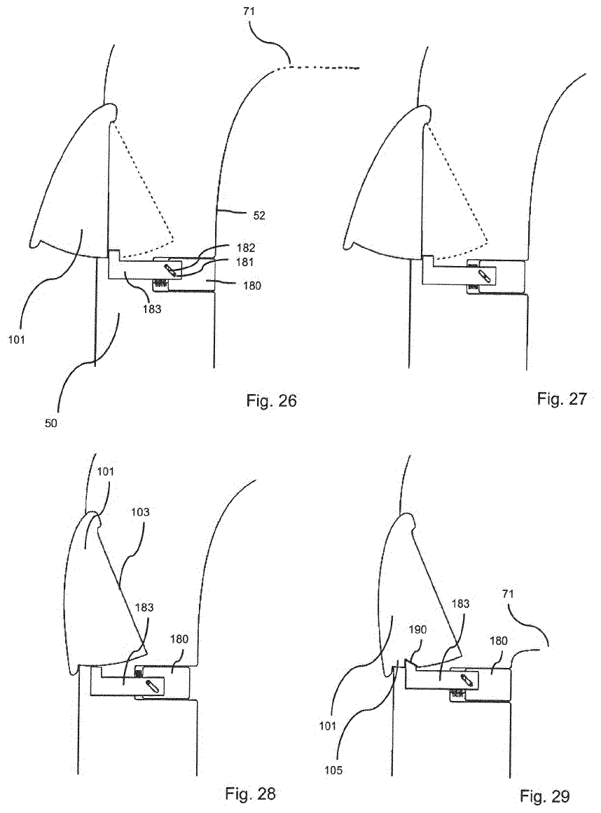

FIG. 26 a further alternative embodiment of a side impact protector according to the invention in functional position with a section of the seat shell;

FIG. 27 the side impact protector according to FIG. 26, but in a position which is no longer fully locked, but maximally unfolded, with a section of the seat shell;

FIG. 28 the side impact protector according to FIG. 26, but in rest position, with a section of the seat shell;

FIG. 29 a further alternative embodiment of a side impact protector according to the invention;

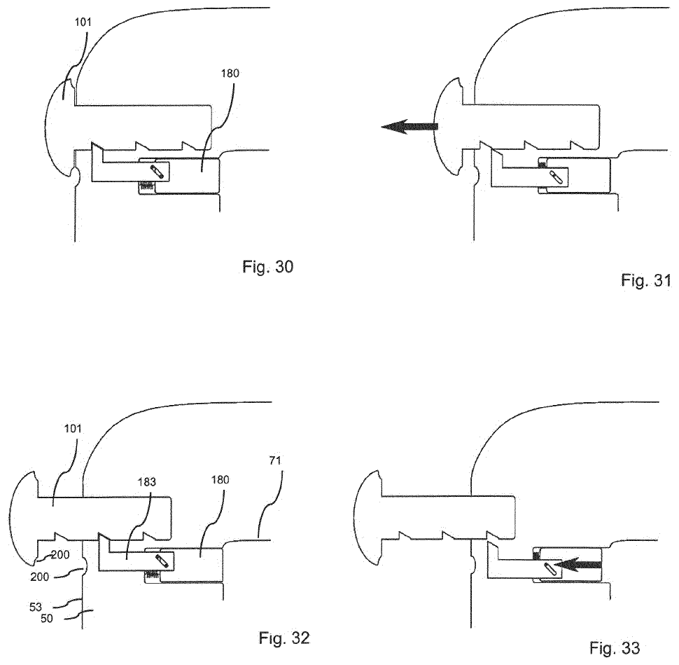

FIG. 30 a further alternative embodiment of a side impact protector according to the invention in rest position with a section of the seat shell;

FIG. 31 the side impact protector according to FIG. 30 in an intermediate position;

FIG. 32 the side impact protector according to FIG. 30 in a first functional position;

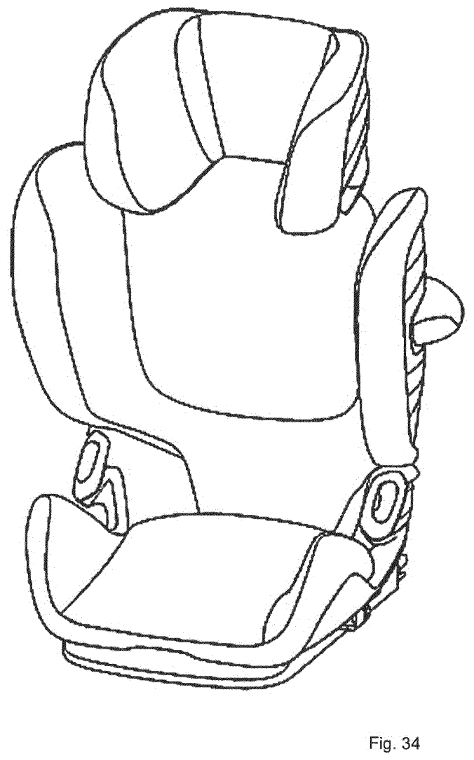

FIG. 33 the side impact protector according to FIG. 30 in a fully extended but not locked position; and

FIG. 34 a child seat according to the invention with side impact protector.

In the following description, the same reference numerals are used for identical and similarly acting parts.

FIG. 1 shows a child seat according to the invent according to ion with side impact protector in the rest position.

The child seat 10 comprises a seat shell 50 attached to a base 20, and an impact shield 90 (both base and impact shield are optional). In other embodiments, it is also possible that parts of the base co-form the seat shell. Here, the base 20 comprises (optionally) a (telescopic) support leg 30 and (also optionally) Isofix latches 40 serving as anchorage.

The seat shell 50 comprises a seat section 60 as well as a back section 70 with a headrest 80, the seat section 60 defining a seating 61 and first side areas 62, and the back section 70 defining a (back) support surface 71 (for laying-on the child's back) and second side areas 72. The headrest 80 also has side areas not specified here and a head support surface.

The seating 61, the support surface 71 as well as the inner sides of the first side areas 62 and second side areas 72 facing a child accommodated in the child seat are part of an inner side 52 of the seat shell 50, which (at least in sections) defines a receptacle space 51 for the child. The sides of the seat shell facing away from a child accommodated in the child seat, in particular the outer sides of the first side areas 62 and second side areas 72, are part of an outer side 53 of the seat shell 50.

On the outer side 53 of the seat shell 50 and according to an embodiment (which is not mandatory) on an outer side of the second side regions 72 a side impact protector 100 is provided. In principle, it would also be possible to provide the side impact protector 100 on an outer side of the first side areas 61 of the seat section 60 or also on an outer side of the side areas of the headrest 80, however, the variant shown here is preferred in the back section 70 (in particular to the rear of the back support surface 71, preferably in relation to the place of attachment in the functional position).

The dashed line marked with the reference sign 54 schematically represents an area of the inner side 52 of the seat shell in which, according to the embodiment, an actuating element 141 of a first locking device 140 shown in detail below (cf. in particular FIGS. 6a to 9) can be accessible. The area 54 shown in FIG. 1 can correspond to a side element which is not visible in FIG. 1 (since it is provided on the opposite outer side of the seat shell), while the area corresponding to the side element 100 shown is also not shown (but is concealed by the second side areas).

FIG. 2 shows the child seat shown in FIG. 1 (in sections) in a side view. In particular, it can be seen here that the side impact protector 100 comprises a side element 101.

FIG. 3 shows an upper section of the child seat shown in FIGS. 1 and 2 in a rear view. In this view, it can be seen that a side impact protector 100 is provided on both the right and the left side of the seat shell 50 (in principle, a side impact protector 100 can also be provided on only one side or on at least one side, or possibly both sides, several side impact protectors). Furthermore, one derives from the illustration that in the rest position shown, the side impact protector 100 does not increase a width of the child seat (or at least not significantly, in particular—if at all—by no more than e.g. 2 cm).

FIG. 4 shows a part of the seat shell of a child seat as well as side impact protector according to the invention in rest position.

The side impact protector 100 is arranged (or attached) in a back section 70 on the outer side 53 of the seat shell 50. It comprises a side element 101, the distal end 105 of which can be moved (or pushed) towards the receptacle area 51 or the seat shell 50 when the side impact protector is in its rest position, in order to release a first locking device 140 explained in detail below and allow a transfer of the side impact protector to the functional position.

In FIGS. 5a, 5b, a part of the seat shell of a child seat and side impact protector according to the invention (corresponding to FIG. 4) is shown in the functional position.

When the side impact protector 100 (in particular its side element 101) is transferred into the functional position, a recess 55 is visible in the outer side 53 of the seat shell, in which the side element is accommodated at least in sections (possibly at least substantially completely in the rest position) and/or only partially in the functional position (for example over at least 20%, possibly at least 30% and/or at most 50%, possibly at most 40% of its length). In the functional position, the proximal end 104 of the side element 101 is closer to the receptacle space 51 or a seat shell 50 than the distal end 105 of the side element 101.

FIG. 6a shows an interior view of a section of the seat shell (without padding/fabric cover). FIG. 6b shows an exploded view of the side impact protector and a section of the seat shell.

The side element 101 can have an upper shell 102 and a lower shell 103 (but not necessarily). In other embodiments, however, it may be assembled in other ways or in one-piece, in particular the side that is not visible in the rest position may be open or open in sections. The side element 101 is mounted on the seat shell 50 via an axis 106, wherein, according to embodiments, the seat shell 50 comprises an element (co-) forming the recess 55, which can also form a support section 56 for the side element. The seat shell 50 can have (in particular in the region of the element forming the recess 55) a through hole 57 for the passage of the latch 143 of a first locking device. Furthermore, the seat shell may comprise a clamp 58 (possibly particularly stable, e.g. made of metal) in which the axle 106 is mounted.

The side element 101 is furthermore connected to the seat shell 50 (here optionally: with the clamp 58) via a spring. On the one hand, this spring serves as a position transfer device 120 (or component thereof) and urges the side element 101 from the functional position or an intermediate position into the functional position. On the other hand, the spring also forms a second resilient element 161 which, as part of a second locking device 160, enables a locking of the functional position.

The first locking device 140 serves to lock the rest position of the side impact protector 100 (in rest position) and is transferable between a locking position and a non-locking position. However, the mere transfer of the side element 101 or the side impact protector 100 into the rest position does not (alone) trigger any locking. This is because the first locking device 140 comprises a first resilient element 142 which biases the first locking device 140 towards the non-locking position. To achieve locking of the side impact protector 100 in its rest position (and thereby prevent the position transfer device 120 from transferring the side element 101 to the functional position), actuation of an actuating element (or, more generally, a first actuating device) 141 is provided, whereby a latch 143 is moved in or through the through hole 57 of the seat shell. At the end of the latch 143 is a hook 144, which can cooperate with an engagement structure 107 of the side impact protector 100 (as further detailed below with further optional details). Actuating element (first actuating device) 141 and latch 143 as well as hook 144 may be formed as different (separate) elements or combined, possibly in one piece.

FIG. 7 shows a sectional view of the side impact protector in rest position as well as a part of the seat shell.

The side impact protector is in its locked rest position. For this purpose, the latch 143 (namely, in the optional embodiment, the hook 144 of the first locking device 140) is in engagement with the engagement structure 107 at the proximal end 104 of the side element 101. The engagement of the hook 144 with the engagement structure 107 prevents the transfer of the first locking device 140 to its non-locking position against the force of the first resilient element 142 (in this case: a compression spring, but this is not mandatory). The latch 143 prevents against the force of the position transfer device 120 the transfer of the side element 101 into the functional position when the first locking device 140 is in the locking position.

The position transfer device 120 (optional here: tension spring) connects the side element 101 to the (optional) clamp 58 (or another part of the child seat or seat shell) and is under tension. Here, the distal end 105 of the side element 101 only approximately (but not entirely, but which may be the case in alternative embodiments) abuts to the seat shell 50 (or the recess 55 of the seat shell 50) and protrudes slightly therefrom.

Preferably, the side element can be moved even further in the direction of the seat shell, so that it possibly abuts fully (or at least abuts even closer to the seat shell). During such a further movement (possible according to the embodiment), however, (preferably) no point of the side element should describe a path which (in relation to a straight connecting line between the starting and end point of the movement) is greater than 2 cm, preferably greater than 1 cm. Optionally, the point describing the largest path may describe a path of at least 1 mm, optionally at least 2 mm.

The side element 101 may comprise an oblong hole 163 (at least according to an embodiment, although this is not mandatory) which extends (at least approximately) in the direction of an (imaginary) connection of the proximal end 104 and the distal end 105, and in which the axle 106 is guided.

The underside of the latch 143 may have a run-up slope, so that if the first locking device 160 is in the locking position (for whatever reason) while the side impact protector 100 is in the functional position, a transfer of the side impact protector 100 from the functional position to the rest position also results in a transfer of the first locking device 160 to the non-locking position by forcing the latch 144 into the through hole 57.

FIG. 8 shows a sectional view of the side impact protector as well as a part of the seat shell according to FIG. 7, but in a maximally folded position beyond the (locked or lockable) rest position.

The side impact protector 100 is in the maximum folded position, which can be achieved for example by pressing the release actuating element (release actuating device), namely the distal end 105 of the side element 101 (in the direction of the seat shell or receptacle space 51), against the force of the position transfer device 120. As a result, the position transfer device is in a maximum tensioned state and the engagement structure 107 has moved away from the latch 143 and the hook 144, so that the first locking device 140 has been transferred to the non-locking position by the bias of the first resilient element 142. The axle is held (cf. also FIG. 7) closer to the proximal end 104 of the oblong hole 164, and the side element 101 now abuts with its distal end 105 (at least partially) to the seat shell 50.

FIG. 9 shows a sectional view of the side impact protector as well as of a part of the seat shell according to FIGS. 7 and 8, but in the functional position.

The side impact protector 100 is in its locked functional position. To achieve this, the bias of the position transfer device 120 has caused the proximal end 104 of the side element 101 to pivot towards the receptacle space 51 or seat shell 50. At the same time, the distal end 105 of the position transfer device 120 was pivoted away from the receptacle space 51 or the seat shell 50 and now protrudes laterally from the seat shell. After the (at least almost) complete pivoting of the side element, the remaining bias of the spring, now in the function as second resilient means 161 and part of a second locking device 160, has pulled the side element 101 towards the receptacle space 51, so that the proximal end 104 (or sections thereof) comes to rest between a first stop 59 and a second stop 162.

In this case, the guidance of the movement is done by the oblong hole 163 and the axle 106, which at the end of the movement is mounted closer to the distal end 105 of the oblong hole 163. In the example shown, the second stop 162 is formed by an edge of the clamp 58 and limits the unfolding of the side element 101. In the example shown, the first stop 59 is formed by an edge of the element forming the return 55 and prevents the side element 101 from folding back or collapsing back into the rest position. The functional position of the side impact protector 100 is locked by these two stops 59 and 162 and the second resilient element 161. After reaching the locked functional position of the side element, the position transfer device 120 or the second resilient element is relaxed (or at least less biased than in the rest position of the side element). The locking can be released again by pulling at the side element (or a part of the side element) away from the receptacle space 51 or the seat shell 50.

FIG. 10 schematically shows three different positions of an alternative embodiment of a side impact protector 100 with a section of the seat shell.

Here too, the side impact protector 100 comprises (or is formed from) a side element 101. The side element 101 is designed to be foldable analogous to the previous embodiments. However, the folded rest position shown (in FIG. 10, centre) cannot be locked by folding alone, but only (see FIG. 10, bottom) by a displacement of the folding element so that a distal end 105 of the side element 101 comes to lie under an undercut 170 of the seat shell 50. Also in this embodiment, the side element can be biased in such a way that it (without locking) is automatically transferred into the functional position (not shown in detail), e.g. by a torsion spring in the area of the axis of rotation. For example, the folding axis can be guided in or on (not shown) rails (e.g. oblong holes) of the seat shell 50 to enable a displacement of the side element 101.

Alternatively, a displacement of the folding element in another direction along the surface of the seat shell may be enabled, the undercut being provided for this purpose in the respective direction. Furthermore, preferably in contrast to the variant shown above in the aforementioned design with undercut as well as the alternative designs, the axis of rotation can be fixed in relation to the seat shell, in which case, for example, an oblong hole in the side element enables the displacement behind the undercut.

FIG. 11 shows a further embodiment of a side impact protector or side element 101 according to the invention. The side element 101 comprises a lower part 103 (or inner part), which can (at least in sections) abut against the seat shell 50 (possibly at a distance of at most 2 cm or at most 0.5 cm or directly) and which can be fastened to the seat shell 50. Further, the side element 101 comprises an upper part 102 (or outer part) configured to protrude from the seat shell (at least in a functional position) and to be contacted by a laterally arranged external surface (e.g. motor vehicle surface, for example inner surface of a motor vehicle door) (at least in the event of an accident, possibly also beforehand in normal use). Lower part 103 and upper part 102 may be detachably or non-detachably connected to each other. A one-piece (possibly monolithic) or multi-part (many-part) design of the respective part and/or parts 102, 103 together is possible. In particular, the parts 103, 102 can form a common part or merge into one another.

A first engagement structure (engagement element) 108 is provided at a first end 104 of the side element 101 (specifically, but not necessarily, of the inner or lower part 103), which can engage with a corresponding counter structure of the seat shell 50. Specifically, the first engagement structure 108 here protrudes from the lower part 103 of the side element 101 (according to an embodiment, in a direction pointing away from the second end 105 as well as the upper (outer) part 102). A corresponding angle may, for example, be at least 10° or at least 20° and/or at most 70° or at most 60° or at most 30° with respect to an inner side of the side element 101.

When the first engagement structure 108 is in engagement with the counter structure of the seat shell 50, it has a retaining (but not necessarily a locking) function. For this reason, the first engagement structure 108 is made preferably (at least comparatively) rigid. At a second end 105 of the side element 101 (specifically a corresponding end of the inner or lower part 103), a second engagement structure (engagement element) 109 is protruding, which can engage in a corresponding counter structure (e.g. receptacle) of the seat shell 50.

The second engagement structure 109 preferably points (at least substantially) in the same direction as the first engagement structure 108, in particular in such a way that both engagement parts 108, 109 (together) predefine (or define) a movement for attaching (fitting) and removing (detaching) the side element 101. The second engagement structure 109 may comprise a latching device (latching nose) 1091. The mode of operation of the second engagement structure (the second engagement element) will be explained further below.

The first end 104 in the embodiment according to FIG. 10 may be a rear end. The second end 105 may be a front end (cf. also the last figure showing a corresponding child seat with the side element 101 according to FIG. 11).

FIG. 12 shows the side element 101 according to FIG. 11 in a view from the inside (from the direction of the seat shell 50). In this view, the lower (inner) part 103 is (at least substantially) visible. It can be seen that the lower (inner) part 103 (which is, however, optional) is detachably connected (e.g. by means of screws) at respective attachment points of the engagement structures 108, 109 to the upper part 102. The second engagement structure 109 has a central section 1092, which in turn comprises (according to embodiment, two) arms 1093 and an actuating section 1094 (as part of an actuating device or forming it). The arms 1093 (or generally the central section 1092) are flexible (and in particular resilient) at least in sections, so that by moving (pressing) the actuating section 1094 towards the outer part or upper part 102, the central section 1092 (central part) acts as (or forms) a leaf spring. Adjacent to the arms 1093 (and optionally extending in the same direction), the second engagement structure 109 further comprises optional lateral parts 1095 which are preferably comparatively rigid (at least in the direction in which the central portion 1092 can be bent). The arms 1093 are preferably located between the lateral parts 1095. Furthermore (according to an embodiment even further out), optional auxiliary elements (generally auxiliary structures) 1096 are located (preferably approximately at the level of the actuation section 1094), which can also engage in corresponding counter structures (e.g. recesses) of the seat shell 50 and can (retainingly) support a fastening of the side element 101 in the seat shell 50.

The auxiliary elements 1096 may be formed as a protrusion or comprise at least one such protrusion (or alternatively or additionally comprise a recess or be formed by such a recess). By means of such auxiliary elements, a safe and reliable positioning can be achieved in a simple manner.

FIG. 13 shows a section of the seat shell 50 for receiving the side element 101 in an external view. The seat shell 50 has a receptacle area (recess) 51 to which the lower part 103 of the side element 101 can be attached. A second (in particular front) section 511 has an (optional) frame (ornamental frame) and a first receptacle (counter structure) 512 for the first engagement structure 108. A first (in particular rear) section 513 of the receptacle area 51 has an optional (preferably round) receptacle 514 for a head of a screw dome as well as (directly adjacent thereto) a second receptacle (counter structure) 515 for the second engagement structure (the second engagement element), namely in particular for the central section (part) 1092 and the two lateral parts 1095. Further outwardly relative to the second receptacle 515, auxiliary receptacles (counter structures) 516 are also provided for the (two) auxiliary structures (auxiliary elements) 1096. A latching edge, which can be (latchingly) engaged by the latching nose already mentioned above, can be seen in FIG. 14.

FIG. 14 shows a section of the seat shell for receiving the side element 101 in a view from the outside (in an oblique direction, in particular from obliquely behind).

The elements and structures shown correspond (at least substantially) to those of FIG. 13.

FIG. 15 shows a section of the seat shell 50 for receiving the side element 101 with the attached side element 101 in an external view.

FIG. 16 shows a section of the seat shell 50 for receiving the side element 101 with the attached side element 101 in a view from the outside (in an oblique direction, in particular from an oblique front).

FIG. 17 shows a view from the inside (i.e. from the area for receiving the child) of a side area 72 of a back section 70 (without covers or softgoods, which may, however, be, or in particular are, provided). The second side area 72 (side panel) has an (outer) rigid shell (hard plastic shell, not to be seen), the inside of which may be covered by a (hard) foam part. An opening (through-hole) 721 may be provided in the second side area (the side panel) 72, in particular in the (hard) foam part, which opening (through-hole) is (at least) large enough for a human finger to fit through it or to accommodate (in cross-section) a circle which can accommodate a diameter of at least 1 cm or at least 1.5 cm and/or at most 8 cm or at most 4 cm (in relation to the upper limits indicated, this is intended to mean in particular that no larger circle than that in the upper limit indicated can be accommodated). The opening 721 lies opposite to the second receptacle 515 of the receptacle area 51. Thus, with the side member 101 attached (plugged on), the actuation section 1094 of the (preferably central) section 1092 of the second engagement structure (engagement element) 109 can be actuated by a (human) finger through the opening 721 in order to disengage the latching device (latching nose) from the counter structure (latching edge) and allow a removal (detaching) of the side member 101 from the seat shell 50.

FIG. 18 shows the opening 721 in an enlarged view (without side element 101). A section of the second receptacle 515, in particular its latching edge, can be seen in the opening 721.

FIG. 19 shows an enlargement of the opening 721 (with side element 101). A section of the second receptacle 515 (in particular its latching edge) can be seen in the opening 721. Furthermore, the actuating section 1094 of the central section (central part) 1092 of the second engagement structure (second engagement element) 109 is visible. Furthermore, the latching nose is in engagement with the latching edge.

FIG. 20 shows a view analogous to FIG. 17, though with softgoods shown but only partially removed (folded away).

FIG. 21 shows a section of a side wall (in particular an outer shell, preferably a plastic shell or hard plastic shell) of the seat shell or child seat. In particular, the receptacle area 51 can be seen here without the attached (fitted) side element 101. The construction shown in FIG. 21 can (in principle) be designed as explained in FIGS. 11-20.

FIG. 22 shows a (roughly) horizontal section through the elements and structures shown in FIG. 21, but here including side element 101, namely (roughly) through a centre of side element 101.

FIG. 23 shows a side view of the side element 101 (similar to FIG. 12, but with slight perspective).

FIG. 24 shows a view similar to that in FIG. 14 (where a viewing angle is chosen such that one can look into the first 512 and second 515 receptacles.

FIG. 25 shows an exploded view of a section of the outer side wall (hard plastic shell) of the child seat or seat shell as well as the side element 101 separated into a lower 103 and upper 102.

Overall, FIGS. 21-25 show basically the embodiment as explained in FIGS. 11-20, with further design (but optional) details.

FIG. 26 shows a schematic sectional view through a section of the wall of a seat shell 50 with foldable side element 101 according to a further embodiment. Here, the side element 101 is possibly not be arranged behind an indicated back support surface 71, but could be arranged behind it. An actuating device 180 is provided which is accessible from the inner side 52. The actuating device 180 can have or form a button (e.g. push button). The actuating device 180 is spring-mounted here (according to embodiment) and has a pin 181 which engages in a sliding block 182 of a latching element 183. The actuating device 180 is preferably movable (displaceable) in the lateral direction. For this purpose, the sliding block 182 is oriented accordingly (namely obliquely, for example at a 45° angle to an actuating direction), so that a (forced) movement in a direction (at least approximately) perpendicular to the lateral direction or direction of movement of the actuating device results for the locking element 183.

FIG. 27 shows the actuating device 180 in a (roughly half) pushed-in or pressed-in position, so that the latching element 183 has begun to move from a latched position (according to FIG. 26) to an unlatched position (cf. FIG. 28). Corresponding springs are visible (about halfway).

FIG. 28 shows the actuating device 180 (fully) pushed-in or pressed-in (generally in an end position) and the latching element 183 in an unlatched position. The side element 101 has been moved from a functional position (FIG. 26) to a rest position. An inner part 103 or inner side (or other inwardly directed structure) of the side element 101 prevents the latching element 103 and the actuating device 180 from moving back to the initial position, so that the at least one spring (the two springs) remains (remain) biased. The embodiment according to FIGS. 26-28 can be combined with a position transfer device (not shown here), wherein the position transfer device is designed to transfer the side element 101 from its functional position to its rest position (and/or vice versa).

FIG. 29 represents an alternative embodiment to those in FIGS. 26-28. This embodiment can basically be executed as explained in FIGS. 26-28, but can have the following differences (each optional in itself). Firstly, the back support surface 71 is here displaced forwards relative to the side element 101 (or the side element 101 is correspondingly displaced backwards), so that the side element 101 is (at least substantially) located behind it (particularly if covers and paddings not yet shown are, as usual, included). Second, a distal end 105 of side element 101 now includes a recess (receptacle) 190 that can receive the latching element 183 when the side element 101 is in the rest position. Thirdly, latching element 183 and receptacle 190 can be designed (e.g. by means of inclined surfaces) in such a way that a rest position of the side element 101 is only maintained if no external force is applied (at least above a predetermined force threshold). If an external force (possibly above a predetermined force threshold) is applied (for example because a user pulls on the side element from the outside), the inclined surfaces can cause the latching element 183 to pull the actuating device 180 (release button) into an engaged position against the force of the at least one spring (of the two springs) and release a transfer of the side element 101 from the rest position to the functional position. This embodiment (according to FIG. 29) can be combined with a position transfer device (not shown), wherein the position transfer device is designed to transfer the side element from its rest position to its functional position (and/or vice versa) so that, for example, only a (slight) pulling is required to overcome the force threshold. To enable (easy) pulling, a suitable engagement option may be provided in the side element 101, for example, an (at least slightly) overhanging end portion (e.g. front portion) may protrude (at least slightly) further from an outer wall of the seat shell 50 at one point.

FIGS. 30-33 show a latching and releasing mechanism analogous to FIGS. 26-29 (in particular analogous to FIG. 29), but with a differently designed (and arranged or movable) side element 101. Here, the side element 101 can be pulled out (or pushed in), namely (optionally) behind the back support surface 71. According to a further embodiment (not shown in detail), the side element 101 can also be designed (in itself) telescopic, for example with at least two sections that can be displaced in relation to each other or at least three sections that can be displaced in relation to each other. The (extendable) side element 101 has a mushroom hat-shaped (mushroom-like) end portion, but this is not mandatory. The mushroom hat-shaped end portion and/or an outer side 53 of the seat shell 50 has/have at least one depression 200 (depressions) for easier gripping behind and extraction of the side element 101, which is also only optional. As in the embodiment example shown in FIGS. 26-29, an embodiment with only one spring and/or with different spring types can alternatively be realised.

According to FIG. 30, the side element 101 is in the rest position, the locking of which is releasable by exceeding a force threshold (by pulling on the side element). Alternatively, a release can be possible via the actuating device 180 (release button).

FIG. 31 illustrates that by pulling on the side element 101 (indicated by the arrow), the side element 101 can be moved from its rest position and is transferred to an (non-latched) intermediate position, whereby the latching element 183 has been forced out of the latched position due to its inclined surface and thereby pulls the actuating device (release button) towards the engaged position against a force of the respective spring (in particular the two springs).

FIG. 32 shows the side element 101 in a first functional position. In this position, it is latched against further extraction only insofar as no (exceeding a force threshold) external (pulling) force is applied. Further pulling out from the outside is therefore possible. In contrast, pushing in towards the rest position is only possible if the actuating device 180 (release button) is actuated. The presence of this position is optional—it is sufficient if a rest position and (only) a functional position are defined.

FIG. 33 shows the side element 101 in the (fully) extended (end) position. To assume the latched end position (or second functional position), the latching element would have to engage in the corresponding recess of the side element 101. However, this is not shown. Rather, a depressed actuating device 108 (release button) is shown, indicated for the case so that the side element 101 can be pushed in towards its rest position (as long as the release button remains depressed).

FIG. 34 shows a child seat according to the invention with a side element analogous to FIGS. 11 to 33.

At this point, it should be noted that all the parts described above, taken individually and in any combination, in particular the details shown in the drawings, are claimed as essential to the invention. Modifications thereof are familiar to the skilled person.

Furthermore, it is pointed out that the broadest possible scope of protection is sought. In this respect, the invention defined in the claims can also be specified by features which are described with further features (without these further features necessarily being included). It is explicitly pointed out that round brackets and the term “in particular”/“particularly” are intended to emphasise the optionality of features in the respective context, which does not mean, conversely, that a feature is to be regarded as mandatory in the corresponding context without such identification.

### REFERENCE SIGNS

10 child seat
20 base
30 telescopic support leg
40 Isofix latches
50 seat shell
51 receptacle space or receptacle area
511 second section
512 first receptacle
513 first section
514 receptacle
515 second receptacle
516 auxiliary receptacle
52 inner side
53 outer side
54 area of the inside 52 of the seat shell
55 recess
57 through hole
58 clamp
59 first stop
90 impact shield
60 seat section
61 seating
62 first side areas
70 back section
71 (back) support surface
72 second side areas
721 opening (through hole)
80 headrest
100 side impact protector
101 side element
102 upper shell (outer part)
103 lower shell (inner part)
104 proximal end (first or rear end)
105 distal end (second or front end)
106 axle
107 engagement structure
108 first engagement structure
109 second engagement structure
1091 latching device (latching nose)
1092 central section
1093 arms
1094 actuating section
1095 lateral parts
1096 auxiliary elements
120 position transfer mechanism
140 first locking mechanism
141 actuating element
142 first resilient element
143 latch
144 hook
160 second locking device
161 second resilient element
162 second stop
163 oblong hole
170 undercut
180 actuating device
181 pin
182 sliding block
183 latching element
196 recess
200 trough

1. A child seat for mounting on a motor vehicle seat, wherein the child seat comprises:
a seat shell, and
a side impact protector which is attached or can be attached to the seat shell and which can be transferred between a rest position located within a predetermined width, and a functional position located outside the predetermined width,
wherein
at least one means for impeding a movement into the rest position or for impeding, or preventing, a permanent setting of the rest position.

2. The child seat according to claim 1,
wherein
a position transfer device for at least partially automatic transfer of the side impact protector from the rest position to the functional position.

3. The child seat according to claim 1,
wherein
the side impact protector is not or at least not exclusively lockable by a complete transfer from the functional position to the rest position.

4. The child seat according to claim 1,
wherein
the means for impeding is configured to impede a release of the locked functional position.

5. The child seat according to claim 1,
wherein
the means for impeding is configured to impede a transfer to the rest position to allow only partial transfer to the rest position.

6. The child seat according to claim 1,
wherein
the side impact protector comprises a side element which can be pivoted or folded.

7. The child seat according to claim 1,
wherein
the side impact protector is not or at least not exclusively lockable by a movement thereof into the rest position or
in that a side element of the side impact protector is not or at least not exclusively lockable by a movement thereof in the rest position.

8. The child seat according to claim 1,
further comprising
a first locking device configured for locking the rest position.

9. The child seat according to claim 1,
further comprising
a second locking device configured for locking the functional position.

10. The child seat according to claim 1,
wherein
the functional position of the side impact protector (alone) is lockable by the complete transfer of the side impact protector into the functional position.

11. The child seat according to claim 1,
wherein
a first locking device comprises a manual, first actuating device for triggering or setting a locking of the rest position, wherein the actuating device:
comprises a knob or a slider or a lever
and/or is not accessible, or only accessible with difficulty, when a child is accommodated in the child seat,
and/or is covered by a cover or padding
and/or has at least two operation elements to be actuated separately
and/or is separated from the side impact protector and/or a side element thereof by at least one separating structure, a separating wall, or a wall of the seat shell
and/or is at a distance of at least 1 cm from the side impact protector and/or a side element thereof
and/or is not visible from the outside and/or inside
and/or is provided on an inner side of the seat shell, at least partially concealed by padding or a cover,
and/or is provided on an outer side of the seat shell, at least partially concealed by a cover,
and/or is actuable against the force of a resilient biasing means,
and/or drives a latch which, or part of which, is provided for engagement with an engagement structure of the side impact protector or side element.

12. The child seat according to claim 1,
wherein
a second locking device comprises a manual, second actuating device for releasing a locking of the functional position, wherein the actuating device:
comprises a knob or slide or lever
and/or is not accessible, or only accessible with difficulty, when a child is accommodated in the child seat,
and/or is covered by a cover or padding
and/or has at least two operation elements to be actuated separately
and/or is separated from the side impact protector and/or a side element thereof by at least one separating structure, a separating wall, or a wall of the seat shell
and/or is at a distance of at least 1 cm from the side impact protector and/or a side element thereof
and/or is not visible from the outside and/or inside
and/or is provided on an inner side of the seat shell, at least partially concealed by padding or a cover,
and/or is provided on an outer side of the seat shell, at least partially concealed by a cover,
and/or is actuable against the force of a resilient biasing means,
and/or drives a latch which, or part of which, is provided for engagement with an engagement structure of the side impact protector or side element.

13. The child seat according to claim 1,
wherein the first locking device comprises a release mechanism formed by the side member or a part of the side member.

14. The child seat according to claim 1,
wherein
the side impact protector comprises or is formed by a side element which is displaceable at least in sections.

15. The child seat according to claim 1,
wherein
the side impact protector comprises or is formed by a side element which is removable at least in sections, in particular completely.

16. The child seat according to claim 1,
wherein
the side impact protector or the side element is transferable from the functional position to a non-locked rest position by a first movement thereof and is lockable in the rest position by a second movement thereof, wherein an axis of movement of the first movement is non-parallel to an axis of movement of the second movement.

17. The child seat according to claim 1,
wherein
the side impact protector comprises or is formed by a side element which can be pivoted or folded for at least partial transfer into the rest position, wherein locking of the rest position can be performed by displacing the side element or a component thereof.

18. The child seat according to claim 1,
wherein
the side impact protector is provided in a back section of the child seat, at the rear of a back support surface, or above a seat section of the child seat or on an outer side of the seat shell.

19. The child seat according to claim 1,
wherein
a side element is formed as an arm projecting to the side in the functional position, extending at least substantially horizontally.

20. A system comprising a child seat for mounting on a motor vehicle seat according to claim 1, and a packaging, wherein the child seat comprises:
a seat shell,
a side impact protector mounted on the seat shell which can be transferred between a rest position located within a predetermined width, and a functional position located outside the predetermined width, and
a position transfer device for at least partially automatically transferring the side impact protector from the rest position to the functional position,
wherein the packaging and the child seat are configured and arranged relative to each other such that the side impact protector is held by the packaging in the rest position or an intermediate position between the rest position and the functional position and upon removal of the packaging is at least partially transferred from the rest position or from the intermediate position to the functional position by the position transfer device.

21. A method of packaging a child seat for mounting on a motor vehicle seat, according to claim 1, wherein the child seat comprises:
a seat shell,
a side impact protector mounted on the seat shell which can be transferred between a rest position located within a predetermined width, and a functional position located outside the predetermined width, and
a position transfer device for at least partially automatically transferring the side impact protector from the rest position to the functional position,
wherein the child seat is packaged in such a way that the side impact protector is held by packaging in the rest position or an intermediate position between the rest position and the functional position and upon removal of the packaging is at least partially transferred from the rest position or the intermediate position into the functional position by the position transfer device.

22. A method for unpacking a child seat for mounting on a motor vehicle seat, according to claim 1, wherein the child seat comprises:
a seat shell,
a side impact protector mounted on the seat shell which can be transferred between a rest position located within a predetermined width, and a functional position located outside the predetermined width, and
a position transfer device for at least partially automatically transferring the side impact protector from the rest position to the functional position,
wherein the packaging is removed from the child seat in such a way that the packaging no longer holds the side impact protector in the rest position or the intermediate position and the position transfer device transfers the side impact protector at least partially into the functional position.

23. A method of configuring a child seat for mounting on a motor vehicle seat, according to claim 1, wherein the child seat comprises:
a seat shell,
a side impact protector attached to the seat shell, which is transferable between a rest position located within a predetermined width, and a functional position located outside the predetermined width, and
a position transfer device for at least partially automatically transferring the side impact protector from the rest position to the functional position,
wherein the side impact protector is not or at least not exclusively locked by a complete transfer from the functional position into the rest position, by actuation of an actuating device or by transfer into a locking position by displacement of at least a section of the side impact protector or at least a section of the side element.
